(19) United States
(12) Patent Application Publication
(10) Pub. No.: US 2025/0280198 A1
(43) Pub. Date: Sep. 4, 2025

(54) LARGE ZOOM RATIO LENS CALIBRATION FOR ELECTRONIC IMAGE STABILIZATION

(71) Applicant: Ambarella International LP, Santa Clara, CA (US)

(72) Inventors: Jian Tang, Shanghai (CN); Xin Gao, Shanghai (CN)

(21) Appl. No.: 18/736,049

(22) Filed: Jun. 6, 2024

Related U.S. Application Data
(63) Continuation-in-part of application No. 18/602,416, filed on Mar. 12, 2024.

(30) Foreign Application Priority Data
Feb. 29, 2024 (CN) 202410234491.X
May 29, 2024 (CN) 202410683014.1

(51) Int. Cl. H04N 23/68; G06T 7/80; H04N 5/91; H04N 17/00

(52) U.S. Cl. CPC H04N 23/683; G06T 7/80; H04N 17/002; H04N 23/6812; G06T 2207/10016; H04N 5/91

(57) ABSTRACT

An apparatus comprising an interface and a processor. The interface may be configured to receive pixel data of an environment and movement information about the apparatus. The processor may be configured to process pixel data arranged as video frames, measure movement information, generate a replay record in response to the video frames of calibration targets captured during a vibration pattern applied to the apparatus and the movement information of the vibration pattern, implement an image stabilization compensation in response to a lens projection function and the movement information, perform an extra compensation in response to calibration values and perform calibration operations to determine the calibration values. The replay record may comprise the video frames generated at a plurality of pre-defined zoom levels of a lens and the calibration operations may comprise determining coordinates of the calibration targets for each of the video frames in the replay record.

This application relates to China Application No. 202410683014.1, filed on May 29, 2024. This application also relates to U.S. patent application Ser. No. 18/602,416, filed Mar. 12, 2024, which relates to China Application No. 202410234491.X, filed on Feb. 29, 2024. Each of the mentioned applications are hereby incorporated by reference in its entirety.

### FIELD OF THE INVENTION

The invention relates to video capture generally and, more particularly, to a method and/or apparatus for implementing large zoom ratio lens calibration for electronic image stabilization.

### BACKGROUND

Electronic image stabilization (EIS) is an important aspect in internet protocol (IP) cameras and other types of cameras. EIS is a highly sophisticated system that involves digital signal processing (DSP) working at a frame-accurate level. Conventional image stabilization techniques do not perform well when the optical zoom reaches high levels (i.e., 10× to 40×). Generally, the image stabilization performs worse as the optical zoom ratio increases.

Conventional image stabilization techniques rely on digital image stabilization (DIS) using pure image processing for lenses with large optical zoom. Without an inertial measurement unit (IMU), DIS has no capability of distinguishing between whether there is external vibration or a relatively large object moving across the field of view. There are other such corner cases where DIS cannot provide acceptable levels of image stabilization.

Each lens used in a camera offers different zoom levels and has different intrinsic characteristics. In order to provide accurate EIS, each lens has to be calibrated individually. Calibrating a lens can involve a lot of manual work from a technician/engineer (i.e., setting up a calibration scene, setting the camera to a particular zoom level, capturing images, etc.). Individually calibrating each lens at different zoom levels is a time consuming process.

It would be desirable to implement large zoom ratio lens calibration for electronic image stabilization.

### SUMMARY

The invention concerns an apparatus comprising an interface and a processor. The interface may be configured to receive pixel data of an environment and movement information about the apparatus. The processor may be configured to process pixel data arranged as video frames, measure movement information, generate a replay record in response to the video frames of calibration targets captured during a vibration pattern applied to the apparatus and the movement information of the vibration pattern, implement an image stabilization compensation in response to a lens projection function and the movement information, perform an extra compensation in response to calibration values and perform calibration operations to determine the calibration values. The replay record may comprise the video frames generated at a plurality of pre-defined zoom levels of a lens and the calibration operations may comprise determining coordinates of the calibration targets for each of the video frames in the replay record, determining a pixel difference matrix in response to a comparison of the video frames determined with the image stabilization compensation and the coordinates of the calibration targets, and generating the calibration values in response to a curve fitting performed on the pixel difference matrix.

### BRIEF DESCRIPTION OF THE FIGURES

Embodiments of the invention will be apparent from the following detailed description and the appended claims and drawings.

FIG. 1 is a diagram illustrating examples of internet protocol cameras that may utilize a processor configured to implement electronic image stabilization for large zoom ratio lens in accordance with example embodiments of the invention.

FIG. 2 is a diagram illustrating example cameras implementing electronic image stabilization for large zoom ratio lens using calibration values.

FIG. 3 is a block diagram illustrating a camera system.

FIG. 4 is a diagram illustrating movement information.

FIG. 5 is a diagram illustrating a graph of total compensation for a range of optical zoom ratios.

FIG. 6 is a diagram illustrating a graph of extra compensation for a range of optical zoom ratios.

FIG. 7 is a diagram illustrating a large zoom ratio lens calibration for electronic image stabilization.

FIG. 8 is a diagram illustrating a camera system capturing calibration targets.

FIG. 9 is a diagram illustrating a pre-defined arrangement of calibration targets.

FIG. 10 is a diagram illustrating a curve representing a total compensation implemented by a capture device.

FIG. 11 is a diagram illustrating curve-fitting to determine calibration values used for extra compensation.

FIG. 12 is a flow diagram illustrating a method for implementing large zoom ratio lens calibration for electronic image stabilization.

FIG. 13 is a flow diagram illustrating a method for performing calibration operations in response to a replay recording.

FIG. 14 is a flow diagram illustrating a method for capturing a recording of calibration targets for a replay record during a vibration pattern.

FIG. 15 is a flow diagram illustrating a method for generating calibration values for cameras during camera manufacturing.

### DETAILED DESCRIPTION OF THE EMBODIMENTS

Embodiments of the present invention include providing large zoom ratio lens calibration for electronic image stabilization that may (i) utilize an inertial measurement unit, the image sensor and digital signal processing at a frame-accurate level, (ii) provide image stabilization at large zoom ratios at which pure digital image stabilization alone does not provide accurate results, (iii) cover all corner cases where digital image stabilization fails, (iv) utilize a vibration frequency and amplitude from an inertial measurement unit, (v) implement a lens projection model, (vi) provide extra compensation with an increasing weight as the optical zoom ratio increases (vii) determine calibration values based on movement information, a pixel shift, an image center distance, and an optical zoom ratio of a lens (viii) calculate the calibration values using a system on a chip, (ix) generate simulation framework records that capture video data and metadata of a calibration configuration, (x) automate synchronizing video data and vibration information to calibrate a lens for a range of pre-defined zoom levels (xi) provide an assessment tool to ensure accuracy of electronic image stabilization results and/or (xii) be implemented as one or more integrated circuits.

Embodiments of the present invention may be configured to provide a calibration system for determining calibration values used for electronic image stabilization (EIS) for a camera while capturing video data. The calibration system may be implemented by a system on a chip (SoC) implemented by a camera device. In one example, the camera may be an internet protocol (IP) camera. In another example, the camera may be a handheld camera. The EIS may be a sophisticated system that combines various data sources to generate stabilized video frames in response to captured pixel data. The various data sources may comprise data from an inertial measurement unit (IMU), an image sensor, and digital signal processing (DSP) in a frame-accurate level. Each camera (or camera lens) may have unique characteristics. The calibration values determined may enable accurate EIS to be performed that takes into account the unique characteristic of each camera.

An inertial measurement unit (IMU) may be implemented to determine the movement information. For example, a gyroscope may be configured to capture a movement of the IP camera while video frames are being captured, and the IMU may convert the movement into movement information. The movement information may be one source of data that may be used to perform the EIS. A vibrating device (e.g., a shaker device) may provide a vibration pattern to shake the capture device during calibration. The vibration pattern may be captured by the IMU and used for determining calibration values.

The EIS may be performed using techniques that determine an appropriate amount of correction that takes into account a lens projection model and movement information. Extra compensation may be performed to deliver a state-of-the-art image stabilization result. In one example, image stabilization using a lens projection model and movement information alone (e.g., a solution that purely uses digital image stabilization) may not perform well when an optical zoom ratio becomes larger (e.g., from approximately 10× to 40× or larger). In another example, solutions that use only digital image stabilization may not be capable of distinguishing between external vibrations and a large object moving across a field of view of the camera. The extra compensation may be configured to provide accurate image stabilization at the large optical zoom ratio. The extra compensation may be configured to provide accurate image stabilization in various corner cases where digital image stabilization alone is incapable of providing accurate results. The combination of the image stabilization using a lens projection model and movement information with the extra stabilization may operate similar to optical image stabilization (OIS). The EIS performed may be compatible with IP cameras that implement computer vision and/or IP cameras that do not implement computer vision. The extra stabilization may rely on the calibration values determined by calibration operations.

In some embodiments, the external vibration compensation may partially depend on the lens projection model. In one example, when the effective focal length (EFL) is relatively small (e.g., a relatively small EFL that may be less than approximately 50 mm), the compensation (e.g., image stabilization) may be largely dependent on the lens projection model. For example, the lens projection model may be one of Equidistant (e.g., f-theta), Stereographic (e.g., tailored distortion), a pin-hole model, etc. In some embodiments, results of the lens projection model may be stored in a look-up table. In another example, when the EFL is relatively large (e.g., a relatively large EFL that may be greater than approximately 50 mm), the extra compensation may provide a higher proportion of the image stabilization compared to the lens projection function. For example, the extra compensation may be determined independent from the lens projection function. Generally, the larger the optical zoom ratio, the more weight (e.g., the higher proportion of contribution to the total amount of compensation for image stabilization) from the extra compensation may be applied.

Embodiments of the present invention may be configured to determine EIS comprising at least two types of compensation. A first amount (e.g., contribution) for the compensation may be determined as a function of a lens geometry distortion projection and the movement information. The second amount (e.g., contribution) for the compensation may be determined as a function of various calibration values. The calibration values may comprise a set of values determined for a particular zoom ratio. For example, each zoom ratio may comprise an individual set of a calibration values. Each of the two types of compensation may apply to all zoom ratios. However, the first amount of contribution (e.g., using the lens geometry distortion projection and movement information) may have a higher weight at lower optical zoom ratios and the second amount of contribution may have a higher weight at higher optical zoom ratios. For example, the amount of compensation from each type of compensation may be a variable ratio and the ratio may be different at the different zoom values and different distances.

The lens geometry distortion may be determined according to various lens optical projection functions (e.g., designs). In some embodiments, a processor may be configured to calculate the lens optical projection function. In some embodiments, a look-up table may be implemented to describe the geometry distortion compensation for the lens optical projection at different angles and/or distances from a point to a lens center. The movement information may comprise a vibration pattern. The vibration pattern may comprise a vibration frequency and a vibration amplitude in each rotation direction (e.g., pitch, yaw and roll). The vibration pattern may be applied during calibration.

The extra compensation may be determined from the intrinsic behavior and/or properties of the lens and/or the movement information. The calibration values may be determined based on a zoom value, a pixel shift, a distance from a point to the center of the lens and/or the movement information. The pixel shift may comprise an additional pixel shift from the ideal geometry distortion projection due to an optical path from zoom impact. A particular result for each of the calibration values may be determined in response to a number of calibration operations. The amount of contribution of each calibration value may be varied according to the design criteria of a particular implementation.

Embodiments of the present invention may be configured to determine the calibration values at a manufacturing time of each camera. The camera may comprise a processor and/or memory (e.g., a system-on-chip) that may be configured to implement a simulation framework and/or calibration operations. The simulation framework may be configured to generate simulation framework records (e.g., replay records). The simulation framework may be configured to synchronize video frames captured with metadata. The metadata may comprise at least the movement data captured by the IMU. The simulation framework may generate the replay records in a format compatible with a calibration device.

A calibration system may comprise a number of calibration targets. The calibration targets may comprise a number of test targets having a pre-defined image pattern. In an example, the pre-defined image pattern may comprise a chessboard (or checkerboard) pattern. The calibration targets may be arranged in a particular layout in the field of view of the camera at various optical zoom levels. The calibration system may comprise a vibration device that applies the vibration to the camera while the camera captures numerous video frames and/or images of the calibration targets. The simulation framework may synchronize the video frames that capture the calibration targets with the movement data captured of the vibration pattern and/or other metadata.

The simulation framework implemented by the camera (e.g., a SoC implemented by the camera) may be configured to partially automate the calibration process. Generally, calibration processes involve a significant amount of manual labor from a technician/engineer. For example, the calibration process may comprise setting up the calibration targets in pre-defined arrangement, setting the camera to a particular zoom level, capturing the video frames at each zoom level and/or calculating the results for each zoom level. The simulation framework may provide time and/or effort savings for a technician/engineer. The simulation framework may be configured to trigger a generation of replay records automatically over a range of zoom levels. For example, the technician/engineer may set up the calibration targets in the pre-defined arrangement for the various zoom levels and trigger the simulation framework and the simulation framework may record the data automatically for a pre-defined range of optical zoom levels.

The calibration operations may be implemented by the camera (e.g., the SoC implemented by the camera). The calibration operations may use the replay records to determine the calibration values for extra compensation. The calibration operations may be configured to analyze the replay records with the application of the first contribution for image stabilization (e.g., based on the lens optical projection functions) and without the extra compensation. The calibration operations may be configured to perform computer vision operations to detect the pattern of the calibration targets. The calibration operations may generate a matrix of values comprising particular locations on the calibration targets. For example, the replay record may comprise hundreds of video frames of the calibration targets and the calibration operations may generate matrices for the particular locations on the calibration targets for each of the video frames in the replay record.

The calibration operations may be configured to generate a pixel difference matrix based on the particular locations on the calibration targets detected and the replay records. The pixel difference matrix may comprise a grid of values that indicate a distance between an actual real-world location of the particular locations (e.g., grid locations) on the calibration targets and the particular locations (e.g., grid locations) on the calibration targets detected when only image projection function is used for image stabilization. Pixel difference matrices may be generated for each zoom level. The calibration operations may be configured to perform curve fitting to determine a set of the calibration values that may be applicable for the extra compensation at a particular zoom ratio. The calibration values may be used by the camera device for performing EIS.

After the camera device determines a set of the calibration values for a particular zoom ratio, the camera system may apply the calibration values to perform the EIS. For example, the total amount of image compensation for the EIS may comprise the first contribution (e.g., based on the lens projection function) and the extra compensation. In some embodiments, the camera system may generate a new set of video frames that may be corrected using the EIS based on the calibration values. The corrected images may be assessed by an EIS assessment tool implemented by the SoC of the camera system. In some embodiments, the calibration values may be applied to the replay records and the EIS assessment tool may assess the output of the replay records with the calibration values applied. The EIS assessment tool may be configured to evaluate an accuracy of the results of the total compensation applied to video frames corrected using the total compensation based on the determined calibration values. If the EIS assessment tool determines the total compensation does not provide accurate results, then the calibration may be repeated to generate a new set of calibration values. If the EIS assessment tool determines the total compensation does provide accurate results, then the set of calibration values may be stored as a set of calibration values for a particular zoom ratio and the calibration operations may determine the next set of calibration values for another one of the zoom ratios.

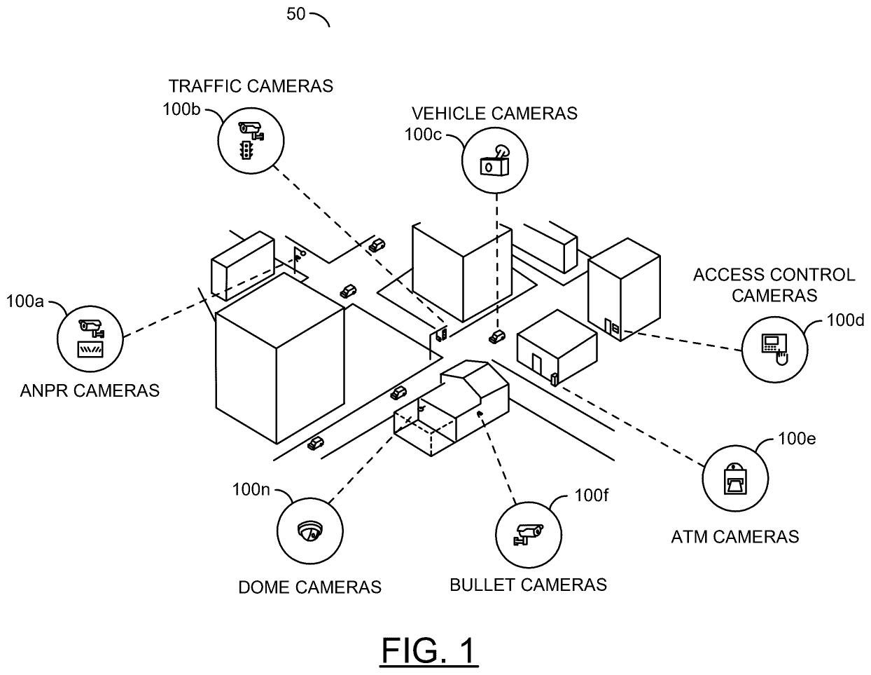

Referring to FIG. 1, a diagram illustrating examples of internet protocol cameras that may utilize a processor configured to implement electronic image stabilization for large zoom ratio lens in accordance with example embodiments of the invention is shown. An overhead view of an area 50 is shown. In the example shown, the area 50 may be an outdoor location. Streets, vehicles and buildings are shown.

Devices 100a-100n are shown at various locations in the area 50. The devices 100a-100n may each implement an edge device. The edge devices 100a-100n may comprise smart IP cameras (e.g., camera systems). The edge devices 100a-100n may comprise low power technology designed to be deployed in embedded platforms at the edge of a network (e.g., microprocessors running on sensors, cameras, or other battery-powered devices), where power consumption is a critical concern. In an example, the edge devices 100a-100n may comprise various traffic cameras and intelligent transportation systems (ITS) solutions.

The edge devices 100a-100n may be implemented for various applications. In the example shown, the edge devices 100a-100n may comprise automated number plate recognition (ANPR) cameras 100a, traffic cameras 100b, vehicle cameras 100c, access control cameras 100d, automatic teller machine (ATM) cameras 100e, bullet cameras 100f, dome cameras 100n, etc. In an example, the edge devices 100a-100n may be implemented as traffic cameras and intelligent transportation systems (ITS) solutions designed to enhance roadway security with a combination of person and vehicle detection, vehicle make/model recognition, and automatic number plate recognition (ANPR) capabilities.

In the example shown, the area 50 may be an outdoor location. In some embodiments, the edge devices 100a-100n may be implemented at various indoor locations. In an example, edge devices 100a-100n may incorporate a convolutional neural network in order to be utilized in security (surveillance) applications and/or access control applications. In an example, the edge devices 100a-100n implemented as security camera and access control applications may comprise battery-powered cameras, doorbell cameras, outdoor cameras, indoor cameras, etc. The security camera and access control applications may realize performance benefits from application of a convolutional neural network in accordance with embodiments of the invention. In an example, an edge device utilizing a convolutional neural network in accordance with an embodiment of the invention may take massive amounts of image data and make on-device inferences to obtain useful information (e.g., multiple time instances of images per network execution) with reduced bandwidth and/or reduced power consumption. In another example, security (surveillance) applications and/or location monitoring applications (e.g., trail cameras) may benefit from a large amount of optical zoom. The design, type and/or application performed by the edge devices 100a-100n may be varied according to the design criteria of a particular implementation.

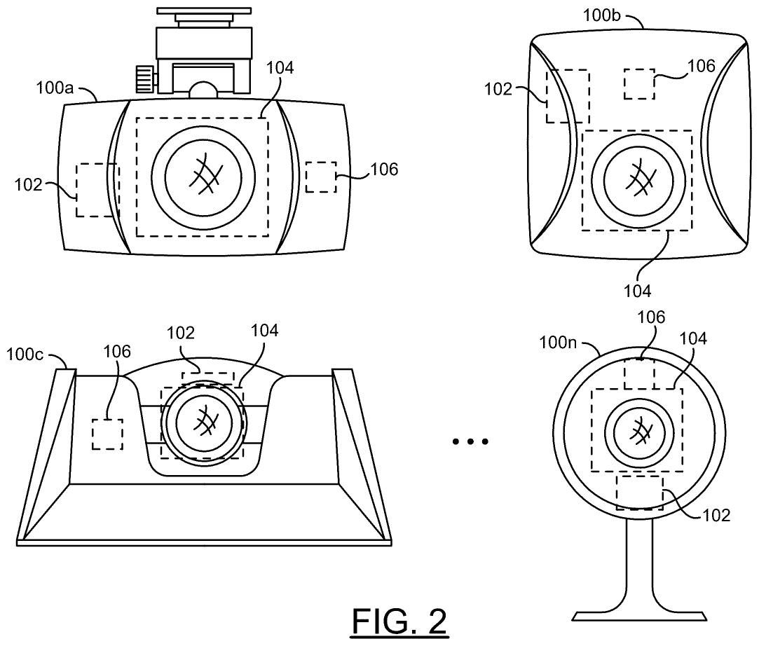

Referring to FIG. 2, a diagram illustrating example cameras implementing electronic image stabilization for large zoom ratio lens using calibration values is shown. The camera systems 100a-100n are shown. Each camera device 100a-100n may have a different style and/or use case. For example, the camera 100a may be an action camera, the camera 100b may be a ceiling mounted security camera, the camera 100n may be a webcam, etc. Other types of cameras may be implemented (e.g., home security cameras, battery powered cameras, doorbell cameras, stereo cameras, etc.). In some embodiments, the camera systems 100a-100n may be stationary cameras (e.g., installed and/or mounted at a single location). In some embodiments, the camera systems 100a-100n may be handheld cameras. In some embodiments, the camera systems 100a-100n may be configured to pan across an area, may be attached to a mount, a gimbal, a camera rig, etc. The design/style of the cameras 100a-100n may be varied according to the design criteria of a particular implementation.

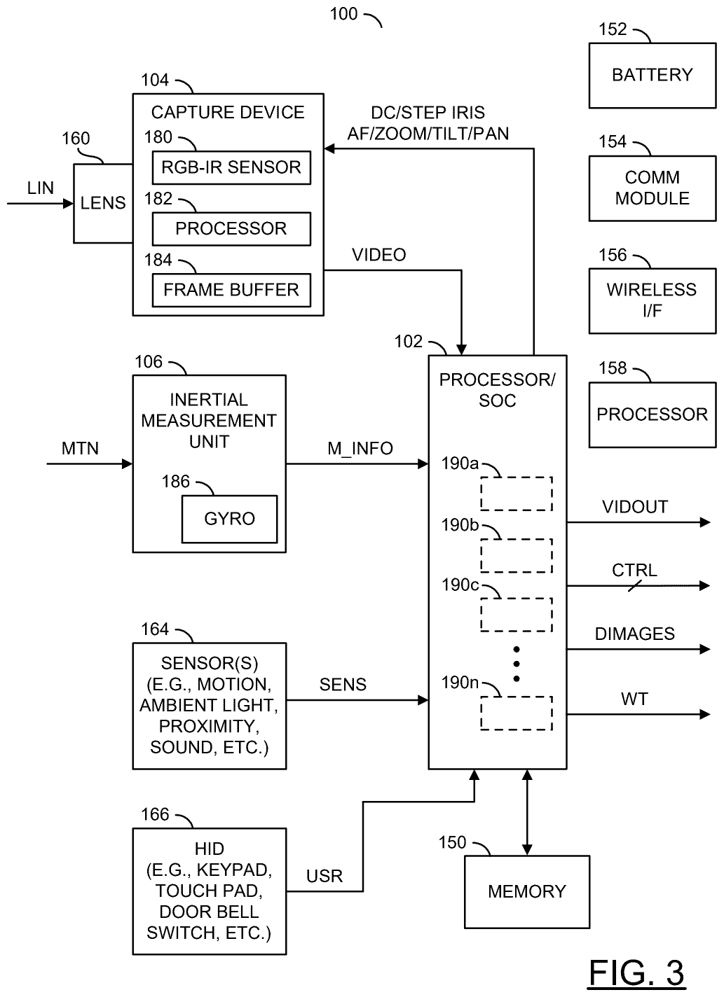

Each of the camera systems 100a-100n may comprise a block (or circuit) 102, a block (or circuit) 104 and/or a block (or circuit) 106. The circuit 102 may implement a processor. The circuit 104 may implement a capture device. The circuit 106 may implement an inertial measurement unit (IMU). The camera systems 100a-100n may comprise other components (not shown). Details of the components of the cameras 100a-100n may be described in association with FIG. 3.

The processor 102 may be configured to implement an artificial neural network (ANN). In an example, the ANN may comprise a convolutional neural network (CNN). The processor 102 may be configured to implement a video encoder. The processor 102 may be configured to process the pixel data arranged as video frames. The capture device 104 may be configured to capture pixel data that may be used by the processor 102 to generate video frames. The IMU 106 may be configured to generate movement data (e.g., vibration information, an amount of camera shake, panning direction, etc.). In some embodiments, a structured light projector may be implemented for projecting a speckle pattern onto the environment. The capture device 104 may capture the pixel data comprising a background image (e.g., the environment) with the speckle pattern. While each of the cameras 100a-100n are shown without implementing a structured light projector, some of the cameras 100a-100n may be implemented with a structured light projector (e.g., cameras that implement a sensor that capture IR light).

The cameras 100a-100n may be edge devices. The processor 102 implemented by each of the cameras 100a-100n may enable the cameras 100a-100n to implement various functionality internally (e.g., at a local level). For example, the processor 102 may be configured to perform object/event detection (e.g., computer vision operations), 3D reconstruction, liveness detection, depth map generation, video encoding, electronic image stabilization and/or video transcoding on-device). For example, even advanced processes such as computer vision and 3D reconstruction may be performed by the processor 102 without uploading video data to a cloud service in order to offload computation-heavy functions (e.g., computer vision, video encoding, video transcoding, etc.).

In some embodiments, multiple camera systems may be implemented (e.g., camera systems 100a-100n may operate independently from each other). For example, each of the cameras 100a-100n may individually analyze the pixel data captured and perform the event/object detection locally. In some embodiments, the cameras 100a-100n may be configured as a network of cameras (e.g., security cameras that send video data to a central source such as network-attached storage and/or a cloud service). The locations and/or configurations of the cameras 100a-100n may be varied according to the design criteria of a particular implementation.

The capture device 104 of each of the camera systems 100a-100n may comprise a single lens (e.g., a monocular camera). The processor 102 may be configured to accelerate preprocessing of the speckle structured light for monocular 3D reconstruction. Monocular 3D reconstruction may be performed to generate depth images and/or disparity images without the use of stereo cameras.

Referring to FIG. 3, a block diagram illustrating a camera system is shown. The camera system (or apparatus) 100 may be a representative example of the cameras 100a-100n shown in association with FIG. 2. The camera system 100 may comprise the processor/SoC 102, the capture device 104, and the IMU 106.

The camera system 100 may further comprise a block (or circuit) 150, a block (or circuit) 152, a block (or circuit) 154, a block (or circuit) 156, a block (or circuit) 158, a block (or circuit) 160, a block (or circuit) 164, and/or a block (or circuit) 166. The circuit 150 may implement a memory. The circuit 152 may implement a battery. The circuit 154 may implement a communication device. The circuit 156 may implement a wireless interface. The circuit 158 may implement a general purpose processor. The block 160 may implement an optical lens. The circuit 164 may implement one or more sensors. The circuit 166 may implement a human interface device (HID). In some embodiments, the camera system 100 may comprise the processor/SoC 102, the capture device 104, the IMU 106, the memory 150, the lens 160, the sensors 164, the battery 152, the communication module 154, the wireless interface 156 and the processor 158. In another example, the camera system 100 may comprise processor/SoC 102, the capture device 104, the IMU 106, the processor 158, the lens 160, and the sensors 164 as one device, and the memory 150, the battery 152, the communication module 154, and the wireless interface 156 may be components of a separate device. The camera system 100 may comprise other components (not shown). The number, type and/or arrangement of the components of the camera system 100 may be varied according to the design criteria of a particular implementation.

In some embodiments, the processor 102 may be implemented as a video processor. In an example, the processor 102 may be configured to receive triple-sensor video input with high-speed SLVS/MIPI-CSI/LVCMOS interfaces. In some embodiments, the processor 102 may be configured to perform depth sensing in addition to generating video frames. In an example, the depth sensing may be performed in response to depth information and/or vector light data captured in the video frames. In some embodiments, the processor 102 may be implemented as a dataflow vector processor. In an example, the processor 102 may comprise a highly parallel architecture configured to perform image/video processing and/or radar signal processing.

The memory 150 may store data. The memory 150 may implement various types of memory including, but not limited to, a cache, flash memory, memory card, random access memory (RAM), dynamic RAM (DRAM) memory, etc. The type and/or size of the memory 150 may be varied according to the design criteria of a particular implementation. The data stored in the memory 150 may correspond to a video file, motion information (e.g., readings from the sensors 164), video fusion parameters, image stabilization parameters, user inputs, computer vision models, feature sets, radar data cubes, radar detections and/or metadata information. In some embodiments, the memory 150 may store reference images. The reference images may be used for computer vision operations, 3D reconstruction, auto-exposure, etc. In some embodiments, the reference images may comprise reference structured light images.

The processor/SoC 102 may be configured to execute computer readable code and/or process information. In various embodiments, the computer readable code may be stored within the processor/SoC 102 (e.g., microcode, etc.) and/or in the memory 150. In an example, the processor/SoC 102 may be configured to execute one or more artificial neural network models (e.g., facial recognition CNN, object detection CNN, object classification CNN, 3D reconstruction CNN, liveness detection CNN, etc.) stored in the memory 150. In an example, the memory 150 may store one or more directed acyclic graphs (DAGs) and one or more sets of weights and biases defining the one or more artificial neural network models. In yet another example, the memory 150 may store instructions to perform transformational operations (e.g., Discrete Cosine Transform, Discrete Fourier Transform, Fast Fourier Transform, etc.). The processor/SoC 102 may be configured to receive input from and/or present output to the memory 150. The processor/SoC 102 may be configured to present and/or receive other signals (not shown). The number and/or types of inputs and/or outputs of the processor/SoC 102 may be varied according to the design criteria of a particular implementation. The processor/SoC 102 may be configured for low power (e.g., battery) operation.

The battery 152 may be configured to store and/or supply power for the components of the camera system 100. The dynamic driver mechanism for a rolling shutter sensor may be configured to conserve power consumption. Reducing the power consumption may enable the camera system 100 to operate using the battery 152 for extended periods of time without recharging. The battery 152 may be rechargeable. The battery 152 may be built-in (e.g., non-replaceable) or replaceable. The battery 152 may have an input for connection to an external power source (e.g., for charging). In some embodiments, the apparatus 100 may be powered by an external power supply (e.g., the battery 152 may not be implemented or may be implemented as a back-up power supply). The battery 152 may be implemented using various battery technologies and/or chemistries. The type of the battery 152 implemented may be varied according to the design criteria of a particular implementation.

The communications module 154 may be configured to implement one or more communications protocols. For example, the communications module 154 and the wireless interface 156 may be configured to implement one or more of, IEEE 102.11, IEEE 102.15, IEEE 102.15.1, IEEE 102.15.2, IEEE 102.15.3, IEEE 102.15.4, IEEE 102.15.5, IEEE 102.20, Bluetooth®, and/or ZigBee®. In some embodiments, the communication module 154 may be a hard-wired data port (e.g., a USB port, a mini-USB port, a USB-C connector, HDMI port, an Ethernet port, a DisplayPort interface, a Lightning port, etc.). In some embodiments, the wireless interface 156 may also implement one or more protocols (e.g., GSM, CDMA, GPRS, UMTS, CDMA2000, 3GPP LTE, 4G/HSPA/WIMAX, SMS, etc.) associated with cellular communication networks. In embodiments where the camera system 100 is implemented as a wireless camera, the protocol implemented by the communications module 154 and wireless interface 156 may be a wireless communications protocol. The type of communications protocols implemented by the communications module 154 may be varied according to the design criteria of a particular implementation.

The communications module 154 and/or the wireless interface 156 may be configured to generate a broadcast signal as an output from the camera system 100. The broadcast signal may send video data, disparity data and/or a control signal(s) to external devices. For example, the broadcast signal may be sent to a cloud storage service (e.g., a storage service capable of scaling on demand). In some embodiments, the communications module 154 may not transmit data until the processor/SoC 102 has performed video analytics and/or radar signal processing to determine that an object is in the field of view of the camera system 100.

In some embodiments, the communications module 154 may be configured to generate a manual control signal. The manual control signal may be generated in response to a signal from a user received by the communications module 154. The manual control signal may be configured to activate the processor/SoC 102. The processor/SoC 102 may be activated in response to the manual control signal regardless of the power state of the camera system 100.

In some embodiments, the communications module 154 and/or the wireless interface 156 may be configured to receive a feature set. The feature set received may be used to detect events and/or objects. For example, the feature set may be used to perform the computer vision operations. The feature set information may comprise instructions for the processor 102 for determining which types of objects correspond to an object and/or event of interest.

In some embodiments, the communications module 154 and/or the wireless interface 156 may be configured to receive user input. The user input may enable a user to adjust operating parameters for various features implemented by the processor 102. In some embodiments, the communications module 154 and/or the wireless interface 156 may be configured to interface (e.g., using an application programming interface (API) with an application (e.g., an app). For example, the app may be implemented on a smartphone to enable an end user to adjust various settings and/or parameters for the various features implemented by the processor 102 (e.g., set video resolution, select frame rate, select output format, set tolerance parameters for 3D reconstruction, etc.).

The processor 158 may be implemented using a general purpose processor circuit. The processor 158 may be operational to interact with the video processing circuit 102 and the memory 150 to perform various processing tasks. The processor 158 may be configured to execute computer readable instructions. In one example, the computer readable instructions may be stored by the memory 150. In some embodiments, the computer readable instructions may comprise controller operations. Generally, input from the sensors 164 and/or the human interface device 166 are shown being received by the processor 102. In some embodiments, the general purpose processor 158 may be configured to receive and/or analyze data from the sensors 164 and/or the HID 166 and make decisions in response to the input. In some embodiments, the processor 158 may send data to and/or receive data from other components of the camera system 100 (e.g., the battery 152, the communication module 154 and/or the wireless interface 156). In some embodiments, the processor 158 may implement an integrated digital signal processor (IDSP). For example, the IDSP 158 may be configured to implement a warp engine. Which of the functionality of the camera system 100 is performed by the processor 102 and the general purpose processor 158 may be varied according to the design criteria of a particular implementation.

The lens 160 may be attached to the capture device 104. The capture device 104 may be configured to receive an input signal (e.g., LIN) via the lens 160. The signal LIN may be a light input (e.g., an analog image). The lens 160 may be implemented as an optical lens. The lens 160 may provide a zooming feature and/or a focusing feature. The capture device 104 and/or the lens 160 may be implemented, in one example, as a single lens assembly. In another example, the lens 160 may be a separate implementation from the capture device 104.

The capture device 104 may be configured to convert the input light LIN into computer readable data. The capture device 104 may capture data received through the lens 160 to generate raw pixel data. In some embodiments, the capture device 104 may capture data received through the lens 160 to generate bitstreams (e.g., generate video frames). For example, the capture devices 104 may receive focused light from the lens 160. The lens 160 may be directed, tilted, panned, zoomed and/or rotated to provide a targeted view from the camera system 100 (e.g., a view for a video frame, a view for a panoramic video frame captured using multiple camera systems 100a-100n, a target image and reference image view for stereo vision, etc.). The capture device 104 may generate a signal (e.g., VIDEO). The signal VIDEO may be pixel data (e.g., a sequence of pixels that may be used to generate video frames). In some embodiments, the signal VIDEO may be video data (e.g., a sequence of video frames). The signal VIDEO may be presented to one of the inputs of the processor 102. In some embodiments, the pixel data generated by the capture device 104 may be uncompressed and/or raw data generated in response to the focused light from the lens 160. In some embodiments, the output of the capture device 104 may be digital video signals.

In an example, the capture device 104 may comprise a block (or circuit) 180, a block (or circuit) 182, and a block (or circuit) 184. The circuit 180 may be an image sensor. The circuit 182 may be a processor and/or logic. The circuit 184 may be a memory circuit (e.g., a frame buffer). The lens 160 (e.g., camera lens) may be directed to provide a view of an environment surrounding the camera system 100. The lens 160 may be aimed to capture environmental data (e.g., the light input LIN). The lens 160 may be a wide-angle lens and/or fish-eye lens (e.g., lenses capable of capturing a wide field of view). The lens 160 may be configured to capture and/or focus the light for the capture device 104. Generally, the image sensor 180 is located behind the lens 160. Based on the captured light from the lens 160, the capture device 104 may generate a bitstream and/or video data (e.g., the signal VIDEO).

The capture device 104 may be configured to capture video image data (e.g., light collected and focused by the lens 160). The capture device 104 may capture data received through the lens 160 to generate a video bitstream (e.g., pixel data for a sequence of video frames). In various embodiments, the lens 160 may be implemented as a fixed focus lens. A fixed focus lens generally facilitates smaller size and low power. In an example, a fixed focus lens may be used in battery powered, doorbell, and other low power camera applications. In some embodiments, the lens 160 may be directed, tilted, panned, zoomed and/or rotated to capture the environment surrounding the camera system 100 (e.g., capture data from the field of view). In an example, professional camera models may be implemented with an active lens system for enhanced functionality, remote control, etc.

The capture device 104 may transform the received light into a digital data stream. In some embodiments, the capture device 104 may perform an analog to digital conversion. For example, the image sensor 180 may perform a photoelectric conversion of the light received by the lens 160. The processor/logic 182 may transform the digital data stream into a video data stream (or bitstream), a video file, and/or a number of video frames. In an example, the capture device 104 may present the video data as a digital video signal (e.g., VIDEO). The digital video signal may comprise the video frames (e.g., sequential digital images and/or audio). In some embodiments, the capture device 104 may comprise a microphone for capturing audio. In some embodiments, the microphone may be implemented as a separate component (e.g., one of the sensors 164).

The video data captured by the capture device 104 may be represented as a signal/bitstream/data VIDEO (e.g., a digital video signal). The capture device 104 may present the signal VIDEO to the processor/SoC 102. The signal VIDEO may represent the video frames/video data. The signal VIDEO may be a video stream captured by the capture device 104. In some embodiments, the signal VIDEO may comprise pixel data that may be operated on by the processor 102 (e.g., a video processing pipeline, an image signal processor (ISP), etc.). The processor 102 may generate the video frames in response to the pixel data in the signal VIDEO.

The signal VIDEO may comprise pixel data arranged as video frames. In some embodiments, the signal VIDEO may be images comprising a background (e.g., objects and/or the environment captured) and the speckle pattern generated by a structured light projector. The signal VIDEO may comprise single-channel source images. The single-channel source images may be generated in response to capturing the pixel data using the monocular lens 160.

The image sensor 180 may receive the input light LIN from the lens 160 and transform the light LIN into digital data (e.g., the bitstream). For example, the image sensor 180 may perform a photoelectric conversion of the light from the lens 160. In some embodiments, the image sensor 180 may have extra margins that are not used as part of the image output. In some embodiments, the image sensor 180 may not have extra margins. In various embodiments, the image sensor 180 may be implemented as an RGB sensor, an RGB-IR sensor, an RCCB sensor, a monocular image sensor, stereo image sensors, a thermal sensor, an event-based sensor, etc. For example, the image sensor 180 may be any type of sensor configured to provide sufficient output for computer vision operations to be performed on the output data (e.g., neural network-based detection). In the context of the embodiment shown, the image sensor 180 may be configured to generate an RGB-IR video signal. In an infrared light only illuminated field of view, the image sensor 180 may generate a monochrome (B/W) video signal. In a field of view illuminated by both IR light and visible light, the image sensor 180 may be configured to generate color information in addition to the monochrome video signal. In various embodiments, the image sensor 180 may be configured to generate a video signal in response to visible and/or infrared (IR) light.

In some embodiments, the camera sensor 180 may comprise a rolling shutter sensor or a global shutter sensor. In an example, the rolling shutter sensor 180 may implement an RGB-IR sensor. In some embodiments, the capture device 104 may comprise a rolling shutter IR sensor and an RGB sensor (e.g., implemented as separate components). In an example, the rolling shutter sensor 180 may be implemented as an RGB-IR rolling shutter complementary metal oxide semiconductor (CMOS) image sensor. In one example, the rolling shutter sensor 180 may be configured to assert a signal that indicates a first line exposure time. In one example, the rolling shutter sensor 180 may apply a mask to a monochrome sensor. In an example, the mask may comprise a plurality of units containing one red pixel, one green pixel, one blue pixel, and one IR pixel. The IR pixel may contain red, green, and blue filter materials that effectively absorb all of the light in the visible spectrum, while allowing the longer infrared wavelengths to pass through with minimal loss. With a rolling shutter, as each line (or row) of the sensor starts exposure, all pixels in the line (or row) may start exposure simultaneously.

The processor/logic 182 may transform the bitstream into a human viewable content (e.g., video data that may be understandable to an average person regardless of image quality, such as the video frames and/or pixel data that may be converted into video frames by the processor 102). For example, the processor/logic 182 may receive pure (e.g., raw) data from the image sensor 180 and generate (e.g., encode) video data (e.g., the bitstream) based on the raw data. The capture device 104 may have the memory 184 to store the raw data and/or the processed bitstream. For example, the capture device 104 may implement the frame memory and/or buffer 184 to store (e.g., provide temporary storage and/or cache) one or more of the video frames (e.g., the digital video signal). In some embodiments, the processor/logic 182 may perform analysis and/or correction on the video frames stored in the memory/buffer 184 of the capture device 104. The processor/logic 182 may provide status information about the captured video frames.

The IMU 106 may be configured to detect motion and/or movement of the camera system 100. The IMU 106 is shown receiving a signal (e.g., MTN). The signal MTN may comprise a combination of forces acting on the camera system 100. The signal MTN may comprise movement, vibrations, shakiness, a panning direction, jerkiness, etc. The signal MTN may represent movement in three dimensional space (e.g., movement in an X direction, a Y direction and a Z direction). The type and/or amount of motion received by the IMU 106 may be varied according to the design criteria of a particular implementation.

The IMU 106 may comprise a block (or circuit) 186. The circuit 186 may implement a motion sensor. In one example, the motion sensor 186 may be a gyroscope. The gyroscope 186 may be configured to measure the amount of movement. For example, the gyroscope 186 may be configured to detect an amount and/or direction of the movement of the signal MTN and convert the movement into electrical data. The IMU 106 may be configured to determine the amount of movement and/or the direction of movement measured by the gyroscope 186. The IMU 106 may convert the electrical data from the gyroscope 186 into a format readable by the processor 102. The IMU 106 may be configured to generate a signal (e.g., M_INFO). The signal M_INFO may comprise the measurement information in the format readable by the processor 102. The IMU 106 may present the signal M_INFO to the processor 102. The number, type and/or arrangement of the components of the IMU 106 and/or the number, type and/or functionality of the signals communicated by the IMU 106 may be varied according to the design criteria of a particular implementation.

The sensors 164 may implement a number of sensors including, but not limited to, motion sensors, ambient light sensors, proximity sensors (e.g., ultrasound, radar, passive infrared, lidar, etc.), audio sensors (e.g., a microphone), etc. In embodiments implementing a motion sensor, the sensors 164 may be configured to detect motion anywhere in the field of view monitored by the camera system 100 (or in some locations outside of the field of view). In various embodiments, the detection of motion may be used as one threshold for activating the capture device 104. The sensors 164 may be implemented as an internal component of the camera system 100 and/or as a component external to the camera system 100. In an example, the sensors 164 may be implemented as a passive infrared (PIR) sensor. In another example, the sensors 164 may be implemented as a smart motion sensor. In yet another example, the sensors 164 may be implemented as a microphone. In embodiments implementing the smart motion sensor, the sensors 164 may comprise a low resolution image sensor configured to detect motion and/or persons.

In various embodiments, the sensors 164 may generate a signal (e.g., SENS). The signal SENS may comprise a variety of data (or information) collected by the sensors 164. In an example, the signal SENS may comprise data collected in response to motion being detected in the monitored field of view, an ambient light level in the monitored field of view, and/or sounds picked up in the monitored field of view. However, other types of data may be collected and/or generated based upon design criteria of a particular application. The signal SENS may be presented to the processor/SoC 102. In an example, the sensors 164 may generate (assert) the signal SENS when motion is detected in the field of view monitored by the camera system 100. In another example, the sensors 164 may generate (assert) the signal SENS when triggered by audio in the field of view monitored by the camera system 100. In still another example, the sensors 164 may be configured to provide directional information with respect to motion and/or sound detected in the field of view. The directional information may also be communicated to the processor/SoC 102 via the signal SENS.

The HID 166 may implement an input device. For example, the HID 166 may be configured to receive human input. In one example, the HID 166 may be configured to receive a password input from a user. In another example, the HID 166 may be configured to receive user input in order to provide various parameters and/or settings to the processor 102 and/or the memory 150. In some embodiments, the camera system 100 may include a keypad, a touch pad (or screen), a doorbell switch, and/or other human interface devices (HIDs) 166. In an example, the sensors 164 may be configured to determine when an object is in proximity to the HIDs 166. In an example where the camera system 100 is implemented as part of an access control application, the capture device 104 may be turned on to provide images for identifying a person attempting access, and illumination of a lock area and/or for an access touch pad 166 may be turned on. For example, a combination of input from the HIDs 166 (e.g., a password or PIN number) may be combined with the liveness judgment and/or depth analysis performed by the processor 102 to enable two-factor authentication. The HID 166 may present a signal (e.g., USR) to the processor 102. The signal USR may comprise the input received by the HID 166.

In embodiments of the camera system 100 that implement a structured light projector, the structured light projector may comprise a structured light pattern lens and/or a structured light source. The structured source may be configured to generate a structured light pattern signal (e.g., a speckle pattern) that may be projected onto an environment near the camera system 100. The structured light pattern may be captured by the capture device 104 as part of the light input LIN. The structured light pattern lens may be configured to enable structured light generated by a structured light source of the structured light projector to be emitted while protecting the structured light source. The structured light pattern lens may be configured to decompose the laser light pattern generated by the structured light source into a pattern array (e.g., a dense dot pattern array for a speckle pattern).

In an example, the structured light source may be implemented as an array of vertical-cavity surface-emitting lasers (VCSELs) and a lens. However, other types of structured light sources may be implemented to meet design criteria of a particular application. In an example, the array of VCSELs is generally configured to generate a laser light pattern (e.g., the signal SLP). The lens is generally configured to decompose the laser light pattern to a dense dot pattern array. In an example, the structured light source may implement a near infrared (NIR) light source. In various embodiments, the light source of the structured light source may be configured to emit light with a wavelength of approximately 940 nanometers (nm), which is not visible to the human eye. However, other wavelengths may be utilized. In an example, a wavelength in a range of approximately 800-1000 nm may be utilized.

The processor/SoC 102 may receive the signal VIDEO, the signal M_INFO, the signal SENS, and the signal USR. The processor/SoC 102 may generate one or more video output signals (e.g., VIDOUT), one or more control signals (e.g., CTRL), one or more depth data signals (e.g., DIMAGES) and/or one or more warp table data signals (e.g., WT) based on the signal VIDEO, the signal M_INFO, the signal SENS, the signal USR and/or other input. In some embodiments, the signals VIDOUT, DIMAGES, WT and CTRL may be generated based on analysis of the signal VIDEO and/or objects detected in the signal VIDEO. In some embodiments, the signals VIDOUT, DIMAGES, WT and CTRL may be generated based on analysis of the signal VIDEO, the movement information captured by the IMU 106 and/or the intrinsic properties of the lens 160 and/or the capture device 104.

In various embodiments, the processor/SoC 102 may be configured to perform one or more of feature extraction, object detection, object tracking, electronic image stabilization, 3D reconstruction, liveness detection and object identification. For example, the processor/SoC 102 may determine motion information and/or depth information by analyzing a frame from the signal VIDEO and comparing the frame to a previous frame. The comparison may be used to perform digital motion estimation. In some embodiments, the processor/SoC 102 may be configured to generate the video output signal VIDOUT comprising video data, the warp table data signal WT and/or the depth data signal DIMAGES comprising disparity maps and depth maps from the signal VIDEO. The video output signal VIDOUT the warp table data signal WT and/or the depth data signal DIMAGES may be presented to the memory 150, the communications module 154, and/or the wireless interface 156. In some embodiments, the video signal VIDOUT the warp table data signal WT and/or the depth data signal DIMAGES may be used internally by the processor 102 (e.g., not presented as output). In one example, the warp table data signal WT may be used by a warp engine implemented by a digital signal processor (e.g., the processor 158).

The signal VIDOUT may be presented to the communication device 156. In some embodiments, the signal VIDOUT may comprise encoded video frames generated by the processor 102. In some embodiments, the encoded video frames may comprise a full video stream (e.g., encoded video frames representing all video captured by the capture device 104). The encoded video frames may be encoded, cropped, stitched, stabilized and/or enhanced versions of the pixel data received from the signal VIDEO. In an example, the encoded video frames may be a high resolution, digital, encoded, de-warped, stabilized, cropped, blended, stitched and/or rolling shutter effect corrected version of the signal VIDEO.

In some embodiments, the signal VIDOUT may be generated based on video analytics (e.g., computer vision operations) performed by the processor 102 on the video frames generated. The processor 102 may be configured to perform the computer vision operations to detect objects and/or events in the video frames and then convert the detected objects and/or events into statistics and/or parameters. In one example, the data determined by the computer vision operations may be converted to the human-readable format by the processor 102. The data from the computer vision operations may be used to detect objects and/or events. The computer vision operations may be performed by the processor 102 locally (e.g., without communicating to an external device to offload computing operations). Similarly other video processing and/or encoding operations (e.g., stabilization, compression, stitching, cropping, rolling shutter effect correction, etc.) may be performed by the processor 102 locally. For example, the locally performed computer vision operations may enable the computer vision operations to be performed by the processor 102 and avoid heavy video processing running on back-end servers. Avoiding video processing running on back-end (e.g., remotely located) servers may preserve privacy.

In some embodiments, the signal VIDOUT may be data generated by the processor 102 (e.g., video analysis results, audio/speech analysis results, stabilized video frames, etc.) that may be communicated to a cloud computing service in order to aggregate information and/or provide training data for machine learning (e.g., to improve object detection, to improve audio detection, to improve liveness detection, etc.). In some embodiments, the signal VIDOUT may be provided to a cloud service for mass storage (e.g., to enable a user to retrieve the encoded video using a smartphone and/or a desktop computer). In some embodiments, the signal VIDOUT may comprise the data extracted from the video frames (e.g., the results of the computer vision), and the results may be communicated to another device (e.g., a remote server, a cloud computing system, etc.) to offload analysis of the results to another device (e.g., offload analysis of the results to a cloud computing service instead of performing all the analysis locally). The type of information communicated by the signal VIDOUT may be varied according to the design criteria of a particular implementation.

The signal CTRL may be configured to provide a control signal. The signal CTRL may be generated in response to decisions made by the processor 102. In one example, the signal CTRL may be generated in response to objects detected and/or characteristics extracted from the video frames. The signal CTRL may be configured to enable, disable, change a mode of operations of another device. In one example, a door controlled by an electronic lock may be locked/unlocked in response the signal CTRL. In another example, a device may be set to a sleep mode (e.g., a low-power mode) and/or activated from the sleep mode in response to the signal CTRL. In yet another example, an alarm and/or a notification may be generated in response to the signal CTRL. The type of device controlled by the signal CTRL, and/or a reaction performed by of the device in response to the signal CTRL may be varied according to the design criteria of a particular implementation.

The signal CTRL may be generated based on data received by the sensors 164 (e.g., a temperature reading, a motion sensor reading, etc.). The signal CTRL may be generated based on input from the HID 166. The signal CTRL may be generated based on behaviors of people detected in the video frames by the processor 102. The signal CTRL may be generated based on a type of object detected (e.g., a person, an animal, a vehicle, etc.). The signal CTRL may be generated in response to particular types of objects being detected in particular locations. The signal CTRL may be generated in response to user input in order to provide various parameters and/or settings to the processor 102 and/or the memory 150. The processor 102 may be configured to generate the signal CTRL in response to sensor fusion operations (e.g., aggregating information received from disparate sources). The processor 102 may be configured to generate the signal CTRL in response to results of liveness detection performed by the processor 102. The conditions for generating the signal CTRL may be varied according to the design criteria of a particular implementation.

The signal DIMAGES may comprise one or more of depth maps and/or disparity maps generated by the processor 102. The signal DIMAGES may be generated in response to 3D reconstruction performed on the monocular single-channel images. The signal DIMAGES may be generated in response to analysis of the captured video data and the structured light pattern.

The multi-step approach to activating and/or disabling the capture device 104 based on the output of the motion sensor 164 and/or any other power consuming features of the camera system 100 may be implemented to reduce a power consumption of the camera system 100 and extend an operational lifetime of the battery 152. A motion sensor of the sensors 164 may have a low drain on the battery 152 (e.g., less than 10 W). In an example, the motion sensor of the sensors 164 may be configured to remain on (e.g., always active) unless disabled in response to feedback from the processor/SoC 102. The video analytics performed by the processor/SoC 102 may have a relatively large drain on the battery 152 (e.g., greater than the motion sensor 164). In an example, the processor/SoC 102 may be in a low-power state (or power-down) until some motion is detected by the motion sensor of the sensors 164.

The camera system 100 may be configured to operate using various power states. For example, in the power-down state (e.g., a sleep state, a low-power state) the motion sensor of the sensors 164 and the processor/SoC 102 may be on and other components of the camera system 100 (e.g., the image capture device 104, the memory 150, the communications module 154, etc.) may be off. In another example, the camera system 100 may operate in an intermediate state. In the intermediate state, the image capture device 104 may be on and the memory 150 and/or the communications module 154 may be off. In yet another example, the camera system 100 may operate in a power-on (or high power) state. In the power-on state, the sensors 164, the processor/SoC 102, the capture device 104, the memory 150, and/or the communications module 154 may be on. The camera system 100 may consume some power from the battery 152 in the power-down state (e.g., a relatively small and/or minimal amount of power). The camera system 100 may consume more power from the battery 152 in the power-on state. The number of power states and/or the components of the camera system 100 that are on while the camera system 100 operates in each of the power states may be varied according to the design criteria of a particular implementation.

In some embodiments, the camera system 100 may be implemented as a system on chip (SoC). For example, the camera system 100 may be implemented as a printed circuit board comprising one or more components. The camera system 100 may be configured to perform intelligent video analysis on the video frames of the video. The camera system 100 may be configured to crop and/or enhance the video.

In some embodiments, the video frames may be some view (or derivative of some view) captured by the capture device 104. The pixel data signals may be enhanced by the processor 102 (e.g., color conversion, noise filtering, auto exposure, auto white balance, auto focus, etc.). In some embodiments, the video frames may provide a series of cropped and/or enhanced video frames that improve upon the view from the perspective of the camera system 100 (e.g., provides night vision, provides High Dynamic Range (HDR) imaging, provides more viewing area, highlights detected objects, provides additional data such as a numerical distance to detected objects, etc.) to enable the processor 102 to see the location better than a person would be capable of with human vision.

The encoded video frames may be processed locally. In one example, the encoded video may be stored locally by the memory 150 to enable the processor 102 to facilitate the computer vision analysis internally (e.g., without first uploading video frames to a cloud service). The processor 102 may be configured to select the video frames to be packetized as a video stream that may be transmitted over a network (e.g., a bandwidth limited network).

In some embodiments, the processor 102 may be configured to perform sensor fusion operations. The sensor fusion operations performed by the processor 102 may be configured to analyze information from multiple sources (e.g., the capture device 104, the IMU 106, the sensors 164 and the HID 166). By analyzing various data from disparate sources, the sensor fusion operations may be capable of making inferences about the data that may not be possible from one of the data sources alone. For example, the sensor fusion operations implemented by the processor 102 may analyze video data (e.g., mouth movements of people) as well as the speech patterns from directional audio. The disparate sources may be used to develop a model of a scenario to support decision making. For example, the processor 102 may be configured to compare the synchronization of the detected speech patterns with the mouth movements in the video frames to determine which person in a video frame is speaking. The sensor fusion operations may also provide time correlation, spatial correlation and/or reliability among the data being received.

In some embodiments, the processor 102 may implement convolutional neural network capabilities. The convolutional neural network capabilities may implement computer vision using deep learning techniques. The convolutional neural network capabilities may be configured to implement pattern and/or image recognition using a training process through multiple layers of feature-detection. The computer vision and/or convolutional neural network capabilities may be performed locally by the processor 102. In some embodiments, the processor 102 may receive training data and/or feature set information from an external source. For example, an external device (e.g., a cloud service) may have access to various sources of data to use as training data that may be unavailable to the camera system 100. However, the computer vision operations performed using the feature set may be performed using the computational resources of the processor 102 within the camera system 100.

A video pipeline of the processor 102 may be configured to locally perform de-warping, cropping, enhancements, rolling shutter corrections, stabilizing, downscaling, packetizing, compression, conversion, blending, synchronizing and/or other video operations. The video pipeline of the processor 102 may enable multi-stream support (e.g., generate multiple bitstreams in parallel, each comprising a different bitrate). In an example, the video pipeline of the processor 102 may implement an image signal processor (ISP) with a 320 MPixels/s input pixel rate. The architecture of the video pipeline of the processor 102 may enable the video operations to be performed on high resolution video and/or high bitrate video data in real-time and/or near real-time. The video pipeline of the processor 102 may enable computer vision processing on 4K resolution video data, stereo vision processing, object detection, 3D noise reduction, fisheye lens correction (e.g., real time 360-degree dewarping and lens distortion correction), oversampling and/or high dynamic range processing. In one example, the architecture of the video pipeline may enable 4K ultra high resolution with H.264 encoding at double real time speed (e.g., 60 fps), 4K ultra high resolution with H.265/HEVC at 30 fps and/or 4K AVC encoding (e.g., 4KP30 AVC and HEVC encoding with multi-stream support). The type of video operations and/or the type of video data operated on by the processor 102 may be varied according to the design criteria of a particular implementation.

The camera sensor 180 may implement a high-resolution sensor. Using the high resolution sensor 180, the processor 102 may combine over-sampling of the image sensor 180 with digital zooming within a cropped area. The over-sampling and digital zooming may each be one of the video operations performed by the processor 102. The over-sampling and digital zooming may be implemented to deliver higher resolution images within the total size constraints of a cropped area.

In some embodiments, the lens 160 may implement a fisheye lens. One of the video operations implemented by the processor 102 may be a dewarping operation. The processor 102 may be configured to dewarp the video frames generated. The dewarping may be configured to reduce and/or remove acute distortion caused by the fisheye lens and/or other lens characteristics. For example, the dewarping may reduce and/or eliminate a bulging effect to provide a rectilinear image.

The processor 102 may be configured to crop (e.g., trim to) a region of interest from a full video frame (e.g., generate the region of interest video frames). The processor 102 may generate the video frames and select an area. In an example, cropping the region of interest may generate a second image. The cropped image (e.g., the region of interest video frame) may be smaller than the original video frame (e.g., the cropped image may be a portion of the captured video).

The area of interest may be dynamically adjusted based on the location of an audio source. For example, the detected audio source may be moving, and the location of the detected audio source may move as the video frames are captured. The processor 102 may update the selected region of interest coordinates and dynamically update the cropped section (e.g., directional microphones implemented as one or more of the sensors 164 may dynamically update the location based on the directional audio captured). The cropped section may correspond to the area of interest selected. As the area of interest changes, the cropped portion may change. For example, the selected coordinates for the area of interest may change from frame to frame, and the processor 102 may be configured to crop the selected region in each frame.

The processor 102 may be configured to over-sample the image sensor 180. The over-sampling of the image sensor 180 may result in a higher resolution image. The processor 102 may be configured to digitally zoom into an area of a video frame. For example, the processor 102 may digitally zoom into the cropped area of interest. For example, the processor 102 may establish the area of interest based on the directional audio, crop the area of interest, and then digitally zoom into the cropped region of interest video frame.

The dewarping operations performed by the processor 102 may adjust the visual content of the video data. The adjustments performed by the processor 102 may cause the visual content to appear natural (e.g., appear as seen by a person viewing the location corresponding to the field of view of the capture device 104). In an example, the dewarping may alter the video data to generate a rectilinear video frame (e.g., correct artifacts caused by the lens characteristics of the lens 160). The dewarping operations may be implemented to correct the distortion caused by the lens 160. The adjusted visual content may be generated to enable more accurate and/or reliable object detection.

Various features (e.g., dewarping, digitally zooming, cropping, etc.) may be implemented in the processor 102 as hardware modules. Implementing hardware modules may increase the video processing speed of the processor 102 (e.g., faster than a software implementation). The hardware implementation may enable the video to be processed while reducing an amount of delay. The hardware components used may be varied according to the design criteria of a particular implementation.

In some embodiments, the processor 102 may implement one or more coprocessors, cores and/or chiplets. For example, the processor 102 may implement one coprocessor configured as a general purpose processor and another coprocessor configured as a video processor. In some embodiments, the processor 102 may be a dedicated hardware module designed to perform particular tasks. In an example, the processor 102 may implement an AI accelerator. In another example, the processor 102 may implement a radar processor. In yet another example, the processor 102 may implement a dataflow vector processor. In some embodiments, other processors implemented by the apparatus 100 may be generic processors and/or video processors (e.g., a coprocessor that is physically a different chipset and/or silicon from the processor 102). In one example, the processor 102 may implement an x86-64 instruction set. In another example, the processor 102 may implement an ARM instruction set. In yet another example, the processor 102 may implement a RISC-V instruction set. The number of cores, coprocessors, the design optimization and/or the instruction set implemented by the processor 102 may be varied according to the design criteria of a particular implementation.

The processor 102 is shown comprising a number of blocks (or circuits) 190a-190n. The blocks 190a-190n may implement various hardware modules implemented by the processor 102. The hardware modules 190a-190n may be configured to provide various hardware components to implement a video processing pipeline, a radar signal processing pipeline and/or an AI processing pipeline. The circuits 190a-190n may be configured to receive the pixel data VIDEO, generate the video frames from the pixel data, perform various operations on the video frames (e.g., de-warping, rolling shutter correction, cropping, upscaling, image stabilization, 3D reconstruction, liveness detection, auto-exposure, etc.), prepare the video frames for communication to external hardware (e.g., encoding, packetizing, color correcting, etc.), parse feature sets, implement various operations for computer vision (e.g., object detection, segmentation, classification, etc.), etc. The hardware modules 190a-190n may be configured to implement various security features (e.g., secure boot, I/O virtualization, etc.). Various implementations of the processor 102 may not necessarily utilize all the features of the hardware modules 190a-190n. The features and/or functionality of the hardware modules 190a-190n may be varied according to the design criteria of a particular implementation. Details of the hardware modules 190a-190n may be described in association with U.S. patent application Ser. No. 16/831,549, filed on Apr. 16, 2020, U.S. patent application Ser. No. 16/288,922, filed on Feb. 28, 2019, U.S. patent application Ser. No. 15/593,493 (now U.S. Pat. No. 10,437,600), filed on May 12, 2017, U.S. patent application Ser. No. 15/931,942, filed on May 14, 2020, U.S. patent application Ser. No. 16/991,344, filed on Aug. 12, 2020, U.S. patent application Ser. No. 17/479,034, filed on Sep. 20, 2021, appropriate portions of which are hereby incorporated by reference in their entirety.

The hardware modules 190a-190n may be implemented as dedicated hardware modules. Implementing various functionality of the processor 102 using the dedicated hardware modules 190a-190n may enable the processor 102 to be highly optimized and/or customized to limit power consumption, reduce heat generation and/or increase processing speed compared to software implementations. The hardware modules 190a-190n may be customizable and/or programmable to implement multiple types of operations. Implementing the dedicated hardware modules 190a-190n may enable the hardware used to perform each type of calculation to be optimized for speed and/or efficiency. For example, the hardware modules 190a-190n may implement a number of relatively simple operations that are used frequently in computer vision operations that, together, may enable the computer vision operations to be performed in real-time. The video pipeline may be configured to recognize objects. Objects may be recognized by interpreting numerical and/or symbolic information to determine that the visual data represents a particular type of object and/or feature. For example, the number of pixels and/or the colors of the pixels of the video data may be used to recognize portions of the video data as objects. The hardware modules 190a-190n may enable computationally intensive operations (e.g., computer vision operations, video encoding, video transcoding, 3D reconstruction, depth map generation, liveness detection, etc.) to be performed locally by the camera system 100.

One of the hardware modules 190a-190n (e.g., 190a) may implement a scheduler circuit. The scheduler circuit 190a may be configured to store a directed acyclic graph (DAG). In an example, the scheduler circuit 190a may be configured to generate and store the directed acyclic graph in response to the feature set information received (e.g., loaded). The directed acyclic graph may define the video operations to perform for extracting the data from the video frames. For example, the directed acyclic graph may define various mathematical weighting (e.g., neural network weights and/or biases) to apply when performing computer vision operations to classify various groups of pixels as particular objects.

The scheduler circuit 190a may be configured to parse the acyclic graph to generate various operators. The operators may be scheduled by the scheduler circuit 190a in one or more of the other hardware modules 190a-190n. For example, one or more of the hardware modules 190a-190n may implement hardware engines configured to perform specific tasks (e.g., hardware engines designed to perform particular mathematical operations that are repeatedly used to perform computer vision operations). The scheduler circuit 190a may schedule the operators based on when the operators may be ready to be processed by the hardware engines 190a-190n.

The scheduler circuit 190a may time multiplex the tasks to the hardware modules 190a-190n based on the availability of the hardware modules 190a-190n to perform the work. The scheduler circuit 190a may parse the directed acyclic graph into one or more data flows. Each data flow may include one or more operators. Once the directed acyclic graph is parsed, the scheduler circuit 190a may allocate the data flows/operators to the hardware engines 190a-190n and send the relevant operator configuration information to start the operators.

Each directed acyclic graph binary representation may be an ordered traversal of a directed acyclic graph with descriptors and operators interleaved based on data dependencies. The descriptors generally provide registers that link data buffers to specific operands in dependent operators. In various embodiments, an operator may not appear in the directed acyclic graph representation until all dependent descriptors are declared for the operands.

One of the hardware modules 190a-190n (e.g., 190b) may implement an artificial neural network (ANN) module. The artificial neural network module may be implemented as a fully connected neural network or a convolutional neural network (CNN). In an example, fully connected networks are “structure agnostic” in that there are no special assumptions that need to be made about an input. A fully-connected neural network comprises a series of fully-connected layers that connect every neuron in one layer to every neuron in the other layer. In a fully-connected layer, for n inputs and m outputs, there are n*m weights. There is also a bias value for each output node, resulting in a total of (n+1)*m parameters. In an already-trained neural network, the (n+1)*m parameters have already been determined during a training process. An already-trained neural network generally comprises an architecture specification and the set of parameters (weights and biases) determined during the training process. In another example, CNN architectures may make explicit assumptions that the inputs are images to enable encoding particular properties into a model architecture. The CNN architecture may comprise a sequence of layers with each layer transforming one volume of activations to another through a differentiable function.

In the example shown, the artificial neural network 190b may implement a convolutional neural network (CNN) module. The CNN module 190b may be configured to perform the computer vision operations on the video frames. The CNN module 190b may be configured to implement recognition of objects through multiple layers of feature detection. The CNN module 190b may be configured to calculate descriptors based on the feature detection performed. The descriptors may enable the processor 102 to determine a likelihood that pixels of the video frames correspond to particular objects (e.g., a particular make/model/year of a vehicle, identifying a person as a particular individual, detecting a type of animal, detecting characteristics of a face, etc.).

The CNN module 190b may be configured to implement convolutional neural network capabilities. The CNN module 190b may be configured to implement computer vision using deep learning techniques. The CNN module 190b may be configured to implement pattern and/or image recognition using a training process through multiple layers of feature-detection. The CNN module 190b may be configured to conduct inferences against a machine learning model.

The CNN module 190b may be configured to perform feature extraction and/or matching solely in hardware. Feature points typically represent interesting areas in the video frames (e.g., corners, edges, etc.). By tracking the feature points temporally, an estimate of ego-motion of the capturing platform or a motion model of observed objects in the scene may be generated. In order to track the feature points, a matching operation is generally incorporated by hardware in the CNN module 190b to find the most probable correspondences between feature points in a reference video frame and a target video frame. In a process to match pairs of reference and target feature points, each feature point may be represented by a descriptor (e.g., image patch, SIFT, BRIEF, ORB, FREAK, etc.). Implementing the CNN module 190b using dedicated hardware circuitry may enable calculating descriptor matching distances in real time.

The CNN module 190b may be configured to perform face detection, face recognition and/or liveness judgment. For example, face detection, face recognition and/or liveness judgment may be performed based on a trained neural network implemented by the CNN module 190b. In some embodiments, the CNN module 190b may be configured to generate the depth image from the structured light pattern. The CNN module 190b may be configured to perform various detection and/or recognition operations and/or perform 3D recognition operations.

The CNN module 190b may be a dedicated hardware module configured to perform feature detection of the video frames. The features detected by the CNN module 190b may be used to calculate descriptors. The CNN module 190b may determine a likelihood that pixels in the video frames belong to a particular object and/or objects in response to the descriptors. For example, using the descriptors, the CNN module 190b may determine a likelihood that pixels correspond to a particular object (e.g., a person, an item of furniture, a pet, a vehicle, etc.) and/or characteristics of the object (e.g., shape of eyes, distance between facial features, a hood of a vehicle, a body part, a license plate of a vehicle, a face of a person, clothing worn by a person, etc.). Implementing the CNN module 190b as a dedicated hardware module of the processor 102 may enable the apparatus 100 to perform the computer vision operations locally (e.g., on-chip) without relying on processing capabilities of a remote device (e.g., communicating data to a cloud computing service).

The computer vision operations performed by the CNN module 190b may be configured to perform the feature detection on the video frames in order to generate the descriptors. The CNN module 190b may perform the object detection to determine regions of the video frame that have a high likelihood of matching the particular object. In one example, the types of object(s) to match against (e.g., reference objects) may be customized using an open operand stack (enabling programmability of the processor 102 to implement various artificial neural networks defined by directed acyclic graphs each providing instructions for performing various types of object detection). The CNN module 190b may be configured to perform local masking to the region with the high likelihood of matching the particular object(s) to detect the object.

In some embodiments, the CNN module 190b may determine the position (e.g., 3D coordinates and/or location coordinates) of various features (e.g., the characteristics) of the detected objects. In one example, the location of the arms, legs, chest and/or eyes of a person may be determined using 3D coordinates. One location coordinate on a first axis for a vertical location of the body part in 3D space and another coordinate on a second axis for a horizontal location of the body part in 3D space may be stored. In some embodiments, the distance from the lens 160 may represent one coordinate (e.g., a location coordinate on a third axis) for a depth location of the body part in 3D space. Using the location of various body parts in 3D space, the processor 102 may determine body position, and/or body characteristics of detected people.

The CNN module 190b may be pre-trained (e.g., configured to perform computer vision to detect objects based on the training data received to train the CNN module 190b). For example, the results of training data (e.g., a machine learning model) may be pre-programmed and/or loaded into the processor 102. The CNN module 190b may conduct inferences against the machine learning model (e.g., to perform object detection). The training may comprise determining weight values for each layer of the neural network model. For example, weight values may be determined for each of the layers for feature extraction (e.g., a convolutional layer) and/or for classification (e.g., a fully connected layer). The weight values learned by the CNN module 190b may be varied according to the design criteria of a particular implementation.

The CNN module 190b may implement the feature extraction and/or object detection by performing convolution operations. The convolution operations may be hardware accelerated for fast (e.g., real-time) calculations that may be performed while consuming low power. In some embodiments, the convolution operations performed by the CNN module 190b may be utilized for performing the computer vision operations. In some embodiments, the convolution operations performed by the CNN module 190b may be utilized for any functions performed by the processor 102 that may involve calculating convolution operations (e.g., 3D reconstruction).

The convolution operation may comprise sliding a feature detection window along the layers while performing calculations (e.g., matrix operations). The feature detection window may apply a filter to pixels and/or extract features associated with each layer. The feature detection window may be applied to a pixel and a number of surrounding pixels. In an example, the layers may be represented as a matrix of values representing pixels and/or features of one of the layers and the filter applied by the feature detection window may be represented as a matrix. The convolution operation may apply a matrix multiplication between the region of the current layer covered by the feature detection window. The convolution operation may slide the feature detection window along regions of the layers to generate a result representing each region. The size of the region, the type of operations applied by the filters and/or the number of layers may be varied according to the design criteria of a particular implementation.

Using the convolution operations, the CNN module 190b may compute multiple features for pixels of an input image in each extraction step. For example, each of the layers may receive inputs from a set of features located in a small neighborhood (e.g., region) of the previous layer (e.g., a local receptive field). The convolution operations may extract elementary visual features (e.g., such as oriented edges, end-points, corners, etc.), which are then combined by higher layers. Since the feature extraction window operates on a pixel and nearby pixels (or sub-pixels), the results of the operation may have location invariance. The layers may comprise convolution layers, pooling layers, non-linear layers and/or fully connected layers. In an example, the convolution operations may learn to detect edges from raw pixels (e.g., a first layer), then use the feature from the previous layer (e.g., the detected edges) to detect shapes in a next layer and then use the shapes to detect higher-level features (e.g., facial features, pets, vehicles, components of a vehicle, furniture, etc.) in higher layers and the last layer may be a classifier that uses the higher level features.

The CNN module 190b may execute a data flow directed to feature extraction and matching, including two-stage detection, a warping operator, component operators that manipulate lists of components (e.g., components may be regions of a vector that share a common attribute and may be grouped together with a bounding box), a matrix inversion operator, a dot product operator, a convolution operator, conditional operators (e.g., multiplex and demultiplex), a remapping operator, a minimum-maximum-reduction operator, a pooling operator, a non-minimum, non-maximum suppression operator, a scanning-window based non-maximum suppression operator, a gather operator, a scatter operator, a statistics operator, a classifier operator, an integral image operator, comparison operators, indexing operators, a pattern matching operator, a feature extraction operator, a feature detection operator, a two-stage object detection operator, a score generating operator, a block reduction operator, and an upsample operator. The types of operations performed by the CNN module 190b to extract features from the training data may be varied according to the design criteria of a particular implementation.

One or more of the hardware modules 190a-190n may be configured to implement other types of AI models. In one example, the hardware modules 190a-190n may be configured to implement an image-to-text AI model and/or a video-to-text AI model. In another example, the hardware modules 190a-190n may be configured to implement a Large Language Model (LLM). Implementing the AI model(s) using the hardware modules 190a-190n may provide AI acceleration that may enable complex AI tasks to be performed on an edge device such as the edge devices 100a-100n.

One of the hardware modules 190a-190n may be configured to perform the virtual aperture imaging. One of the hardware modules 190a-190n may be configured to perform transformation operations (e.g., FFT, DCT, DFT, etc.). The number, type and/or operations performed by the hardware modules 190a-190n may be varied according to the design criteria of a particular implementation.

Each of the hardware modules 190a-190n may implement a processing resource (or hardware resource or hardware engine). The hardware engines 190a-190n may be operational to perform specific processing tasks. In some configurations, the hardware engines 190a-190n may operate in parallel and independent of each other. In other configurations, the hardware engines 190a-190n may operate collectively among each other to perform allocated tasks. One or more of the hardware engines 190a-190n may be homogeneous processing resources (all circuits 190a-190n may have the same capabilities) or heterogeneous processing resources (two or more circuits 190a-190n may have different capabilities).

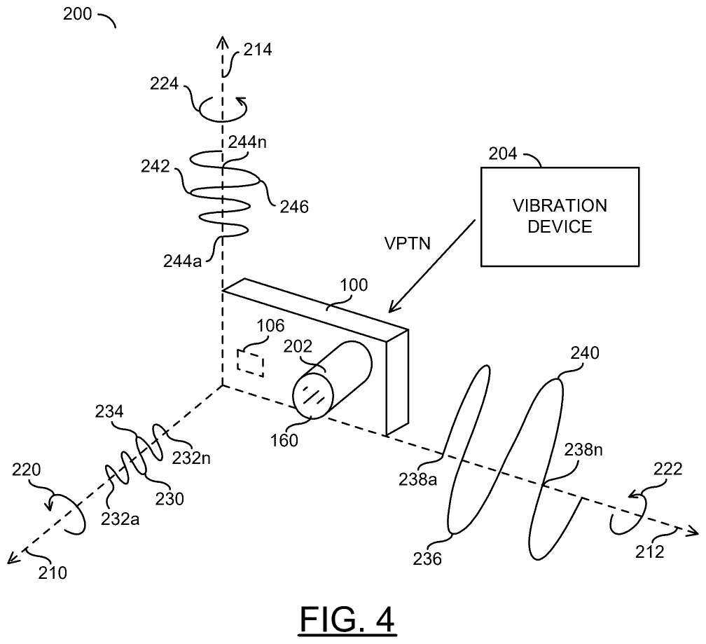

Referring to FIG. 4, a diagram illustrating movement information is shown. A coordinate system 200 is shown. The camera system 100 is shown on the coordinate system 200. The IMU 106 and the lens 160 of the camera 100 are shown.

The camera system 100 may implement an optical zoom 202. For example, the lens 160 may provide an optical zoom 202. In some embodiments, the lens 160 may enable the optical zoom 202 and the processor 102 may further implement a digital zoom. The optical zoom 202 may enable the environment and/or objects captured to appear physically closer before the pixel data is captured. For example, the digital zoom may be a form of post-processing performed by the processor 102 and the optical zoom 202 may be a physical process performed by the lens 160 that may increase magnification. The optical zoom 202 may be implemented in response to moving parts within the camera lens 160. For example, the lens 160 may be adjusted in order to increase a focal length. Generally, the optical zoom 202 may enlarge a subject of the video frames while preserving image quality. In one example, the optical zoom 202 may be a 5× zoom. In another example, the optical zoom 202 may be a 10× zoom. In yet another example, the optical zoom 202 may be a 40× zoom. In some embodiments, the camera system 100 may implement a selectable optical zoom 202 in a range from 1× zoom to 83× zoom. The amount of the optical zoom 202 implemented may be varied according to the design criteria of a particular implementation.

A block (or circuit) 204 is shown. The circuit 204 may implement a vibration device (or a calibration shaker). The vibration device 204 may be configured to generate a signal (e.g., VPTN). In the example shown, the signal VPTN is shown as being presented to the camera system 100 for illustrative purposes. Generally, the signal VPTN may be used internally by the vibration device 204. In some embodiments, the camera system 100 may implement an actuator that may vibrate in response to the signal VPTN. In some embodiments, the vibration device 204 may present the signal VPTN to a vibrating platform. In an example, the vibration device 204 may be a standalone device comprising a platform for the camera system 100 to sit upon. The implementation of the vibration device 204 may be varied according to the design criteria of a particular implementation.

The signal VPTN may enable a vibration pattern. The vibration pattern may be configured to shake, vibrate and/or actuate the camera system 100. In some embodiments, the vibration pattern generated by the vibration device 204 may be a pre-defined pattern (e.g., a pattern stored in a memory that may be known in advance). In some embodiments, the vibration pattern generated by the vibration device 204 may be random and/or pseudo-random. The vibration pattern may be implemented to cause the instability when the capture device captures pixel data at various levels of the optical zoom 202 of the lens 160. For example, the electronic image stabilization implemented by the camera system 100 may be configured to counteract and/or correct the vibration pattern generated by the vibration device 204. The calibration operations performed by the processor 102 and/or the memory 150 may be configured to determine the calibration values in response to measurements performed while the vibration device 204 generates the vibration pattern VPTN. The vibration pattern VPTN may not be known in advance to the camera system 100. The type and/or particular pattern of the vibration pattern VPTN applied to the camera system 100 may be varied according to the design criteria of a particular implementation.

The coordinate system 200 is shown as a dashed arrow 210, a dashed arrow 212 and a dashed arrow 214. The arrow 210 may represent an X-axis. The arrow 212 may represent a Y-axis. The arrow 214 may represent a Z-axis. The camera system 100 is shown at an origin of the coordinate system 200. Motion may be applied to the camera system 100, which may result in the motion MTN. For example, various amounts of force may be applied to the camera system 100 along the axes 210-214.

A curved arrow 220 is shown as a rotation around the X-axis 210. The curved arrow 220 may represent a roll rotation. A curved arrow 222 is shown as a rotation around the Y-axis 212. The curved arrow 222 may represent a pitch rotation. A curved arrow 224 is shown as a rotation around the Z-axis 214. The curved arrow 224 may represent a yaw rotation. The combination of motion MTN applied to the camera system 100 may cause the camera system 100 to have the roll rotation 220, the pitch rotation 222 and/or the yaw rotation 224. The IMU 106 may be configured to detect the various roll rotation 220, pitch rotation 222 and/or yaw rotation 224.

A curve 230 is shown on the X-axis 210. The curve 230 may represent a vibration on the X-axis 210. The vibration 230 may be one type of motion applied to the camera system 100 that may be measured by the IMU 106. The curve 230 is shown as a sinusoidal curve having a frequency 232a-232n and an amplitude 234. The frequency 232a-232n and the amplitude 234 may represent a component of the movement and/or vibration that results in the roll rotation 220.

A curve 236 is shown on the Y-axis 212. The curve 236 may represent a vibration on the Y-axis 212. The vibration 236 may be one type of motion applied to the camera system 100 that may be measured by the IMU 106. The curve 236 is shown as a sinusoidal curve having a frequency 238a-238n and an amplitude 240. The frequency 238a-238n and the amplitude 240 may represent a component of the movement and/or vibration that results in the pitch rotation 222.

A curve 242 is shown on the Z-axis 214. The curve 242 may represent a vibration on the Z-axis 214. The vibration 242 may be one type of motion applied to the camera system 100 that may be measured by the IMU 106. The curve 242 is shown as a sinusoidal curve having a frequency 244a-244n and an amplitude 246. The frequency 244a-244n and the amplitude 246 may represent a component of the movement and/or vibration that results in the yaw rotation 224.

The IMU 106 may convert the frequency 232a-232n and the amplitude 234 of the vibration 230 for the roll rotation 220, the frequency 238a-238n and the amplitude 240 of the vibration 236 for the pitch rotation 222 and/or the frequency 244a-244n and the amplitude 246 of the vibration 242 for the yaw rotation 224 to the motion information signal M_INFO. The vibrations 230-242 may result in motion (e.g., shakiness) in the captured pixel data VIDEO. The processor 102 may be configured to perform the compensation to counteract the motion to generate the stabilized video frames VIDOUT. Generally, as the amount of the optical zoom 202 increases, the more of an effect the vibrations 230-242 may have the amount of motion visible in the raw video data. For example, at large optical zoom levels (e.g., above 10×) even a small amount of movement may appear as a large amount of movement captured in the video frames.

During calibration, the vibration device 204 may apply the vibration pattern VPTN to the camera system 100. For example, during calibration the input MTN read by the IMU 106 may be the vibration pattern VPTN generated by the vibration device 204. The IMU 106 may be configured to read and/or store the vibration pattern sensed as the vibration pattern VPTN is applied. For example, the vibration device 204 may be a calibration shaker configured with various shake amplitudes and frequencies. The vibration pattern VPTN may comprise a combination of various amounts of the frequency 232a-232n and the amplitude 234 in the roll rotation 220, the frequency 238a-238n and the amplitude 240 in the pitch rotation 222 and/or the frequency 244a-244n and the amplitude 246 in the yaw rotation 224. Generally, in response to detecting the vibration pattern VPTN (or other motion input MTN), the IMU 106 may detect and/or record a maximum amplitude (degrees), an actual amplitude (degrees), an actual angle value (degrees), a vibration frequency (Hz) and/or a vibration duration (seconds). The processor may be configured to correlate (e.g., based on timestamp information and/or duration of the vibration pattern) the movement information captured by the IMU 106 with the video data captured by the processor 102 during the calibration.

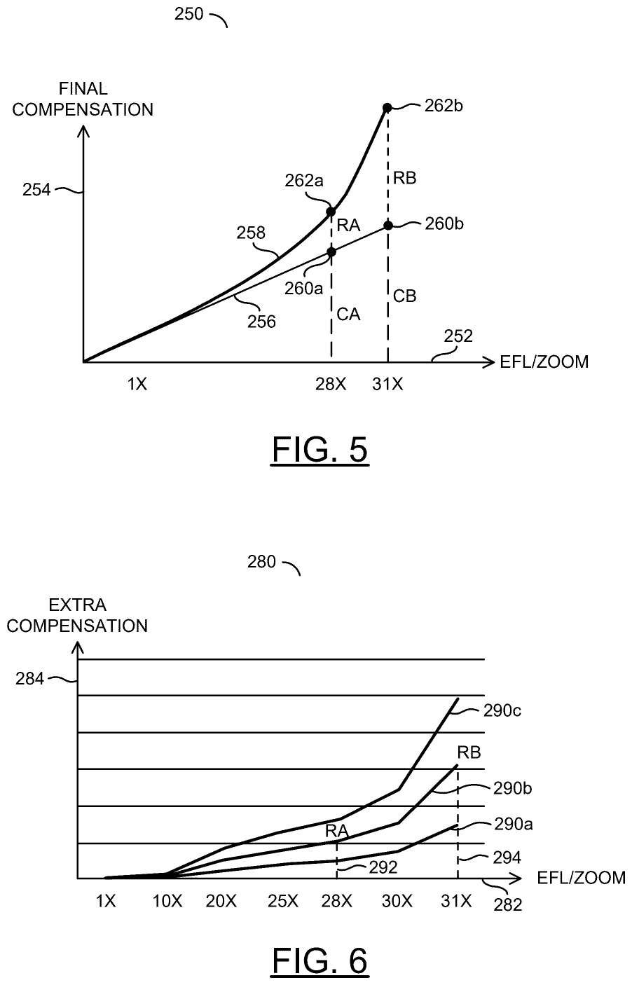

Referring to FIG. 5, a diagram illustrating a graph of total compensation for a range of optical zoom ratios is shown. A graph 250 is shown. The graph 250 may comprise an axis 252 and an axis 254. The axis 252 may be an X-axis. The X-axis 252 may illustrate an amount of EFL and/or zoom ratio. The axis 254 may be a Y-axis. The Y-axis 254 may represent an amount of final compensation (e.g., FC) for the image stabilization performed. The graph 250 may illustrate a compensation ratio for electronic image stabilization at different zoom levels.

The graph 250 may comprise a curve 256 and a curve 258. The curve 256 may represent an amount of compensation performed in response to only image stabilization compensation (e.g., based on the lens projection function and the movement information). The image stabilization compensation curve 256 is generally shown as linear. For example, as the zoom ratio increases, the amount of the image stabilization compensation increases linearly. The linear increase of the image stabilization compensation may be insufficient to account for larger optical zoom levels.

The curve 258 may represent an amount of compensation performed (e.g., a total compensation) in response to both the image stabilization compensation and the extra compensation (e.g., based on the calibration values). The extra compensation curve 258 is generally shown as non-linear. For example, as the zoom ratio increases, the amount of the extra compensation may increase non-linearly. The non-linear increase of the extra compensation may accurately account for the distortion caused by larger optical zoom levels.

The image stabilization compensation performed by the processor 102 may implement one or more lens projection functions. In one example, the lens projection function may be an equidistant lens projection function (e.g., the f-theta model). The equidistance lens projection function may be determined according to an equation (e.g., EQ1):

$$c = f * Θ \qquad EQ 1$$

In another example, the lens projection function may be a stereographic lens projection function (e.g., the tailored distortion model). The stereographic lens projection function may be determined according to an equation (e.g., EQ2):

$$c = 2 * f * tan ( Θ / 2 ) \qquad EQ 2$$

In yet another example, the lens projection function may be a pin hole lens projection function. The pin hole lens projection function may be determined according to an equation (e.g., EQ3):

$$c = f * tan ( Θ ) \qquad EQ 3$$

In still another example, the lens projection function may be precalculated for various values of Θ and stored in a lookup table in the memory 150. The value of Θ may represent an incident angle for each pixel of image. The image stabilization compensation performed by the processor 102 may determine the result of the lens projection function to provide the image stabilization compensation. The particular lens projection function implemented and/or method of determining a result of the lens projection function may be varied according to the design criteria of a particular implementation.

The extra compensation may be added to the image stabilization compensation for any amount of the optical zoom 202 (e.g., from 1× zoom up to the maximum zoom level). Generally, for larger optical zooms, the amount of compensation may be outside of the bounds of the general lens projection function. For example, the larger the optical zoom 202 is, the more weight that is applied from the extra compensation. In one example, a large optical zoom ratio may be greater than approximately 10× zoom. In another example, the large optical zoom ratio may be when the EFL is greater than 50 mm. The amount of optical zoom ratio and/or EFL that may be considered a large optical zoom may be varied according to the design criteria of a particular implementation.

A point 260a and a point 260b are shown on the image stabilization compensation curve 256. The points 260a-260b may be an amount of compensation (e.g., CA-CB, respectively). The amount of compensation CA-CB may represent a contribution of the image stabilization compensation generated by the image stabilization compensation performed by the processor 102 based on the lens projection function and the motion information. The amount of compensation CA and the point 260a may correspond to a zoom level of 28×. The amount of compensation CB and the point 260b may correspond to a zoom level of 31×. The amount of compensation CB may be a linear increase compared to the compensation CA that corresponds to the difference between the zoom level 31× and the zoom level 28×.

A point 262a and a point 262b are shown on the extra compensation curve 258 above the respective points 260a-260b. An amount of extra compensation RA is shown extending from the point 260a to the point 262a and an amount of extra compensation RB is shown extending from the point 260b to the point 262b. The amount of extra compensation RA-RB may represent a contribution of the extra compensation generated by the extra compensation performed by the processor 102 based on the calibration values. The points 262a-262b may be an amount of total compensation (e.g., CA+RA and CB+RB, respectively). The amount of extra compensation RA and the point 262a may correspond to a zoom level of 28×. The amount of extra compensation RB and the point 262b may correspond to a zoom level 31×. The amount of extra compensation RB may be a non-linear increase compared to the amount of extra compensation RA that corresponds to the difference between the zoom level 31× and the zoom level 28×. The non-linear relationship between the increase in optical zoom and the amount of extra compensation may enable the final compensation to accurately compensate the distortion caused by larger optical zoom ratios.

The total amount of compensation may be represented by an equation (e.g., EQ4):

$$Total compensation = R ( k 1 * EFL * r , k 2 * h , k 3 * r \hat{} 2 ) \qquad EQ 4$$

The equation EQ4 for determining the total amount of compensation may be calculated by a combination of the image stabilization compensation and/or the extra compensation module. The value of EFL*r may be determined in response to the optical zoom ratio and/or the pixel shift. The optical zoom ratio may be determined in response to an optical zoom reading from the lens 160. For example, the optical zoom ratio may be converted to an effective focal length (e.g., in a pixel unit value). The processor 102 may implement a zoom driver configured to read from a zoom lens motor that adjusts the zoom level of the lens 160. The zoom lens motor may present a zoom level and/or a change in zoom level to the zoom driver and the zoom driver may convert the optical zoom ratio 202 to EFL value in pixel unit value in real time. The pixel shift may be determined from the ideal geometry distortion projection due to the optical path from the zoom impact. The amount of pixel shift may be determined based on the amount of distortion caused by the zoom and/or the shape of the lens 160. The pixel shift may be an additional pixel shift from the ideal geometry distortion projection that may result from the effect of the zoom on the optical path. The pixel shift may be a result of the shape of the lens 160 and/or a wide angle effect of the lens 160. The amount of the pixel shift may be determined in response to performing the image stabilization compensation (e.g., based on the lens projection function and the movement information). The value h may represent a frequency. The frequency may be the external vibration frequency that may be generated in response to the analysis of the IMU 106. The radius may be a radius measurement that indicates the distance to the image center. The radius may be determined based on a point from the optical center of the lens 160 that depends on the focal length f and the incident angle Θ. In one example, the radius may be determined according to the equation LR=f(Θ).

The values k1, k2 and k3 may be the calibration values. The calibration operations may be performed using a self-designed calibration system to determine the calibration values. The calibration values k1, k2 and k3 may be scalar values. In one example, the calibration value k1 may be a scalar value for the pixel shift and the optical zoom, the calibration value k2 may be a scalar value for the movement information, and the calibration value k3 may be a scalar value for the image center distance. Details of the pixel shift, the optical zoom and/or the image center distance may be described in association with U.S. patent application Ser. No. 18/602,416, filed Mar. 12, 2024, appropriate portions of which are incorporated by reference.

The EIS implemented by the processor 102 may comprise contributions from two components (e.g., the image stabilization compensation and the extra compensation). The image stabilization compensation (e.g., c) may be a function of the lens geometry distortion projection and/or a vibration pattern. The lens geometry distortion may be determined from various different lens optical projection designs. For example, various lens optical projection designs are shown in EQ1-EQ3. Other lens optical projections designs may be implemented (e.g., c=2*sin (Θ/2)). Other more complicated lens optical projection designs may be implemented. For example, the look-up table in the memory 150 may be implemented to describe the geometry distortion compensation for the lens optical projection at different angles and/or distances from a particular point to the optical center of the lens 160. The motion information may comprise the frequency 232a-232n and the amplitude 234 of the vibration 230 for the roll rotation 220, the frequency 238a-238n and the amplitude 240 of the vibration 236 for the pitch rotation 222 and/or the frequency 244a-244n and the amplitude 246 of the vibration 242 for the yaw rotation 224.

The extra compensation (e.g., r) may be determined from an intrinsic behavior of the lens and/or the motion information. The total compensation for EIS may comprise a variable ratio of the extra compensation to the image stabilization compensation. The ratio may be different at different zoom values and/or different distances. As the zoom value increases, the ratio of the amount of extra compensation with respect to the image stabilization compensation may increase (e.g., increase non-linearly). The extra compensation may comprise a combination of several factors. One factor may be a zoom value. Another factor may be an additional pixel shift from the ideal geometry distortion projection due to the optical path resulting from the effect of the zoom. Yet another factor may be a distance from the point (e.g., the pixel location) to the optical center of the lens 160. Still another factor may be the movement information. The amount of contribution of each of the factors may be determined by the calibration values.

Referring to FIG. 6, a diagram illustrating a graph of extra compensation for a range of optical zoom ratios is shown. A graph 280 is shown. The graph 280 may comprise an axis 282 and an axis 284. The axis 282 may be an X-axis. The X-axis 282 may illustrate an amount of EFL and/or zoom ratio. The axis 284 may be a Y-axis. The Y-axis 284 may represent an amount of extra compensation (e.g., r) for the electronic image stabilization performed. The graph 280 may demonstrate the compensation ratio for different zoom lens vendors even at the same zoom levels. Since each lens vendor may have different compensation ratios, the calibration may be performed on each camera lens during manufacturing.

The graph 280 may comprise curves 290a-290c. The curves 290a-290c may represent the extra compensation determined for different types of zoom lenses (e.g., zoom lens A, zoom lens B, and zoom lens C). The extra compensation curves 290a-290c may represent a padding value of different zoom lenses (e.g., a padding for the extra compensation to be added to the image stabilization compensation). In one example, the zoom lenses A-C may represent various large optical zoom lens products (e.g., a Thorlab's zoom lens, a Navitar zoom lens, a Opteka zoom lens, a Canon EF-S55 lens, etc.). The particular lenses implemented may be varied according to the design criteria of a particular implementation.

Each of the extra compensation curves 290a-290c may increase at different rates depending on the intrinsic properties of the zoom lenses. For example, extra compensation curve 290c for the zoom lens C may have the highest values of extra compensation and the extra compensation curve 290a for the zoom lens A may have the lowest values of extra compensation. Generally, at low values of the optical zoom 202 (e.g., a low range of optical zoom ratios) the amount of the extra compensation of the extra compensation curves 290a-290c may be negligible. In the example shown, the negligible values for the extra compensation curves may correspond to zoom values of approximately 10× zoom. However, there may not be a particular threshold zoom value for every lens where the contribution from the extra compensation is negligible (e.g., some lenses may a larger amount of extra compensation at 10× zoom and lower that may not be negligible). Generally, the negligible contribution to the extra compensation may be a comparison with respect to the amount of compensation provided by the image stabilization compensation (e.g., from the general lens projection function). Generally, each zoom ratio may have a particular compensation factor. Each lens may have a unique extra compensation curve (e.g., even if some of the extra compensation values may overlap with extra compensation curves for other types of zoom lenses).

In one example, the zoom lens curve 290b may correspond to the curve 258 in association with FIG. 5. A dashed line 292 and a dashed line 294 are shown. The dashed line 292 may represent an amount of extra compensation (e.g., RA) for the zoom lens B at a zoom ratio of 28×. Similarly, the dashed line 294 may represent an amount of extra compensation (e.g., RB) for the zoom lens B at a zoom ratio of 31×. For example, the dashed line 292 may correspond to the RA value between the point 260a and the point 262a shown in association with FIG. 5, and the dashed line 294 may correspond to the RB value between the point 260b and the point 262b shown in association with FIG. 5.

Generally, for a small zoom ratio, the extra compensation factor may be very small (e.g., negligible, close to zero, relatively small compared to the image stabilization compensation value, etc.). Generally, for larger zoom ratios, the extra compensation factor may be a more prominent value in the final (or total) compensation. For example, as the optical zoom ratio 202 increases, the extra compensation may be the dominant factor in the EIS correction. In one example, larger zoom ratios may be at values larger than 10×. In the example shown in association with FIG. 5, the extra compensation may begin to dominate the total compensation at approximately 31× zoom. While the graph 280 shows an upper zoom ratio value of 31×, the extra compensation (e.g., and the equation EQ4) may be applicable to even larger zoom ratios. The extra compensation curves 290a-290c may increase non-linearly. In one example, the increase of the extra compensation curves 290a-290c may be an exponential function (e.g., e\hat{ }x). In another example, the increase of the extra compensation curves 290a-290c may be a power function or cubic function (e.g., x\hat{ }2, x\hat{ }3). The type of non-linear increase of the extra compensation curves 290a-290c may be varied according to the design criteria of a particular implementation.

Generally, the extra compensation may provide an additional amount of compensation that may be related to the amount of the optical zoom 202 and/or the intrinsic characteristics of the lens 160. For example, the curves 290a-290c may represent the additional compensation for different lens types. The curves 290a-290c may be represented by a fitted line up to a particular value of the optical zoom 202. In one example, a slope of 1 for the fitted line may be considered a threshold for a large amount of compensation or a low amount of compensation. For example, when the slope of a fitted line for one of the curves 290a-290c is above 1, then the amount of compensation may be considered large or high. In another example, when the slope of a fitted line for one of the curves 290a-290c is below 1, then the amount of compensation may be considered small or low. The particular slope value that may be used as a threshold for a low or high amount of compensation may be varied according to the design criteria of a particular implementation.

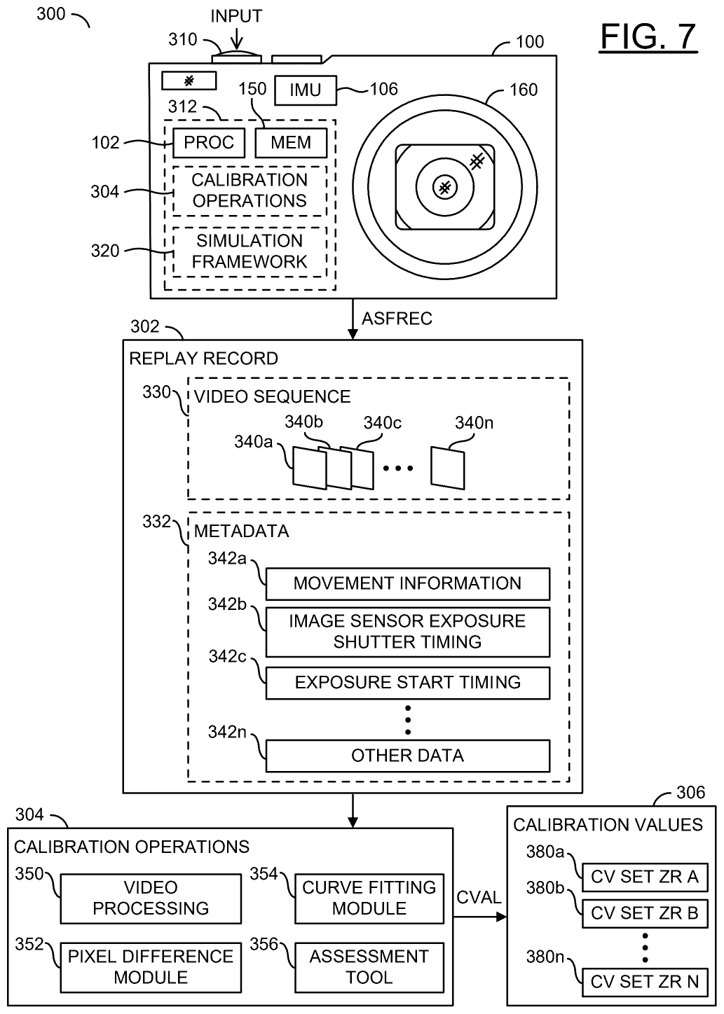

Referring to FIG. 7, a diagram illustrating a large zoom ratio lens calibration for electronic image stabilization is shown. Calibration components 300 are shown. The calibration components 300 may comprise the camera system 100, a replay record 302, calibration operations 304 and/or calibration values 306. The calibration components 300 may comprise other components (not shown). In some embodiments, the calibration components 300 may further comprise the vibration device 204. The number, type and/or arrangement of the components of the calibration components 300 may be varied according to the design criteria of a particular implementation.

The camera system 100 is shown comprising the lens 160, a button 310 and/or a block (or circuit) 312. The button 310 is shown receiving a signal (e.g., INPUT). The signal INPUT may be a physical input provided by a user (e.g., a technician/engineer performing the calibration of the camera system 100). In the example shown, the button 310 may be a physical button. In some embodiments, the button 310 may be a software button (e.g., implemented on a touchscreen interface). In some embodiments, the signal INPUT may be provided electronically. For example, the calibration operations 304 may provide the signal INPUT to start the calibration. The implementation of the button 310 and/or the initiation of the calibration may be varied according to the design criteria of a particular implementation.

The camera system 100 may be configured to generate a signal (e.g., CVAL) and/or generate a signal (e.g., ASFREC). The signal CVAL may comprise the calibration values generated by the calibration operations 304. The signal ASFREC may comprise replay records generated by the circuit 312. In some embodiments, the signal ASFREC may be presented to a device external to the camera system 100. For the calibration operations 304, the signal ASFREC may be used internally by the camera system 100. In some embodiments, the signal CVAL may be presented to a device external to the camera system 100. For the calibration operations 304, the signal CVAL may be used internally by the camera system 100. The number, type and/or format of the signals generated by and/or received by the camera system 100 may be varied according to the design criteria of a particular implementation.

The circuit 312 may comprise one or more of the components implemented by the camera system 100 (e.g., the components shown in association with FIG. 3). In one example, the circuit 312 may comprise a circuit board. In another example, the circuit 312 may be a SoC. In the example shown, the circuit 312 may be a SoC that implements the processor 102 and/or the memory 150. The SoC 312 may be configured to perform the EIS by implementing the total compensation (e.g., the combination of the image compensation stabilization and the extra compensation as shown in the equation EQ4). In the example shown, the circuit 312 may comprise the processor 102 and/or the memory 150 and the IMU 106 is implemented separately. In some embodiments, the circuit 312 may be a SoC that implements each of the processor 102, the memory 150 and/or the IMU 106. The number, type and/or arrangement of the components of the circuit 312 may be varied according to the design criteria of a particular implementation.

The SoC 312 is shown comprising the calibration operations 304 and/or a block (or circuit) 320. The calibration operations 304 and/or the block 320 may each comprise computer executable instructions. The computer executable instructions of the block 320, when executed by the processor 102 may implement a simulation framework. In one example, the simulation framework 320 may be a proprietary simulation framework specific to the processor 102. A combination of the processor 102 and the memory 150 may implement the computer executable instructions for the calibration operations 304 and/or the simulation framework 320. For example, the computer executable instructions may be stored in the memory 150, read from the memory 150 by the processor 102 and executed by the processor 102. The SoC 312 may comprise other computer readable data and/or computer executable instructions.

The simulation framework 320 may be configured to generate the replay records. For example, the simulation framework 320 may generate the data communicated in the signal ASFREC. The simulation framework 320 may run/operate on (e.g., be executed by) the camera system 100. The simulation framework 320 may be configured to record the motion data that provides the vibration context for the video frames. The simulation framework 320 may be configured to pack and/or format the data for the replay records in a format that may be recognized by the calibration operations 304. In some embodiments, the simulation framework 320 implemented by the camera system 100 may depend upon the calibration operations 304 used for the calibration components 300.

The simulation framework 320 may be configured to synchronize video frames generated by the processor 102 with metadata. The metadata may comprise at least the movement information captured by the IMU 106. The metadata may further comprise data such as the exposure shutter timing of the image sensor 180, and/or a start timing of the exposure of the image sensor 180. For example, during calibration, the vibration device 204 may generate the vibration pattern VPTN while the camera system 100 generates the video frames and/or reads the motion information. The simulation framework 320 may synchronize the video frames generated by the processor 102 during the vibration pattern VPTN with the motion data generated by the IMU 106 of the vibration pattern VPTN. The synchronized video frames and motion information may be recorded as the replay records.

The replay record 302 is shown. In the example shown, a single replay record 302 is shown for illustrative purposes. Generally, the simulation framework 320 may generate more than one replay record. The replay record 302 may be a record stage for the calibration operations 304. In the recording stage, the camera system 100 may be configured with the zoom lens 160 to a specific zoom ratio (e.g., Nx zoom ratio), then start recording metadata and video frames. For example, one replay record may be generated for each of the zoom levels (e.g., where Nx iterates from 1× zoom to a maximum zoom level). The replay record 302 may be stored in the memory 150. For example, the memory 150 may store the replay record 302 for later use by the calibration operations 304 performed by the SoC 312. The replay record 302 may comprise a block (or computer readable data) 330 and/or a block (or computer readable data) 332. The block 330 may implement a video sequence. The block 332 may implement metadata. The replay record 302 may comprise other data (not shown). The type and/or format of the data in the replay record 302 may be varied according to the design criteria of a particular implementation.

The video sequence 330 may comprise video frames 340a-340n. The video frames 340a-340n of the video sequence 330 may comprise a number of video frames captured during the vibration pattern VPTN. For example, the number of the video frames 340a-340n captured in the video sequence 330 may depend on the length of the vibration pattern VPTN. In one example, the number of video frames 340a-340n in the video sequence 330 may be at least 600 video frames. More of the video frames 340a-340n may be captured when the vibration pattern VPTN is complex. Generally, the more complex the vibration in the vibration pattern VPTN, the more of the video frames 340a-340n may be captured in the video sequence 330 for the replay record 302. In one example, each of the video frames 340a-340n may comprise YUV frames. In another example, each of the video frames 340a-340n may comprise compressed video frames. For example, the video frames 340a-340n may comprise high quality HEVC I frames. In another example, the video frames 340a-340n may comprise AV1 encoded frames. In yet another example, the video frames 340a-340n may comprise x264 encoded frames. The number and/or formation of the video frames 340a-340n in the video sequence 330 may be varied according to the design criteria of a particular implementation.

The replay record 302 may comprise the video sequence 330 with the metadata 332 all synchronized with each of the video frames 340a-340n. The metadata 332 may comprise a block (or computer readable data) 342a-342n. In the example shown, the block 342a may comprise movement information, the block 342b may comprise image sensor exposure shutter timing, the block 342c may comprise exposure start timing and the block 342n may comprise other data. The type of data stored in the metadata 332 may be varied according to the design criteria of a particular implementation.

The movement information 342a may be generated by the IMU 106. For example, the movement information 342a may comprise gyroscope sample data sequences (e.g., real time gyro data). The movement information 342a may further comprise gyro output data frequency and/or full scale range of gyro raw data. The movement information 342a may be generated during the vibration pattern VPTN and synchronized by the simulation framework 320 to the video sequence 330. The image sensor exposure shutter timing 342b and/or the exposure start timing 342c may comprise sensor timing data used to capture the video frames 340a-340n during the vibration pattern VPTN. The sensor timing data may be synchronized by the simulation framework 320 to the video sequence 330. The other data 342n may comprise other types of metadata (e.g., a resolution of the video sequence 330, which may be the same as the raw image resolution).

The replay record 302 may be stored by the memory 150 and/or used for the calibration operations 304. In some embodiments, the calibration operations 304 may be performed by the SoC 312 (e.g., the processor 102). In some embodiments, the calibration operations 304 may be performed by a separate computing device. In one example, the replay records 302 may be communicated to a separate computing device configured to perform the calibration operations 304 (e.g., a desktop computer, a laptop computer, a smartphone, a tablet computing device, a cloud computing device, etc.). For example, a calibration device configured to perform the calibration operations may comprise a CPU and/or a memory. The CPU of the external calibration device may be configured to receive and/or analyze data and make decisions in response to the input. In one example, the CPU may implement one of a 32-bit instruction set (e.g., x86), a 64-bit instruction set (e.g., AMD64), an ARM instruction set, a RISC-V instruction set, etc., The memory may store data. The memory of the external calibration device may implement various types of memory including, but not limited to, a cache, flash memory, a memory card, random access memory (RAM), dynamic RAM (DRAM) memory, etc. configured to store an operating system (OS) and programs/applications (e.g., apps, a dashboard interface, etc.). The apps may operate on various operating system platforms (e.g., Windows, iOS, Linux, Android, Windows Phone, macOS, Chromium OS/Chrome OS, Fuchsia, Blackberry, etc.). Generally, the SoC 312 may comprise sufficient computing resources to perform the calibration operations 304 locally (e.g., with no separate calibration device).

The calibration operations 304 may be performed locally on the camera system 100. The calibration operations 304 may be a replay stage. In the replay stage, on-camera computations may be run in order to calculate the chessboard location from the captured video frames 340a-340n and a pixel shift difference table, then do curve fitting to get the final results. In one example, the calibration operations 304 may be configured to implement a companion application that may be configured to interface with the camera system 100. The companion application may enable users to view video captured by the edge devices 100a-100n (e.g., directly from the edge devices 100a-100n and/or streamed via a cloud service). The calibration operations 304 may comprise a block (or circuit) 350, a block (or circuit) 352, a block (or circuit) 354, and/or a block (or circuit) 356. The circuit 350 may implement a video processing pipeline. The circuit 352 may implement a pixel difference module. The circuit 354 may implement a curve fitting module. The circuit 356 may implement an assessment tool. The calibration operations 304 may comprise other components (not shown). For example, one or more of the components 350-356 may be implemented by a combination of the hardware modules 190a-190n. The number, type and/or arrangement of the components of the calibration operations 304 may be varied according to the design criteria of a particular implementation.

The video processing pipeline 350 may be configured to analyze and/or operate on the video frames 340a-340n in the video sequence 330. In one example, the video processing pipeline 350 may be an iDSP of the processor 102. The iDSP implementing the video processing pipeline 350 may receive the replay record 302. The iDSP implementing the video processing pipeline 350 may be configured to parse and replay the video sequence 340a-340n and the metadata 332. The video processing pipeline 350 may be configured to detect objects (e.g., calibration targets). The video processing pipeline 350 may be configured to detect intersection points on the calibration targets (e.g., golden coordinates, true coordinates, etc.). For example, the video processing pipeline 350 may determine coordinates in 3D space of a grid displayed on the calibration targets.

The pixel difference module 352 may be configured to generate a pixel difference matrix. The pixel difference module 352 may be configured to compare and/or determine a difference between the location of the grids determined by the video processing pipeline 350 and the location of the grids in the video sequence 330 with the image compensation stabilization implemented (but without the extra compensation). For example, the pixel difference matrix generated by the pixel difference module 352 may represent the amount of extra compensation that may be applied for EIS.

The curve fitting module 354 may be configured to generate the calibration values. The curve fitting module 354 may be configured to analyze the pixel difference matrices to determine the amount of extra compensation that may be desirable to achieve accurate electronic image stabilization. Based on the amount of extra compensation that may be desirable, the curve fitting module 354 may determine the calibration values. The curve fitting module 354 may be configured to implement various types of curve fitting techniques in order to solve the multi-variable equation for determining the calibration values. The combination of variables that fit the curve for the extra compensation based on the pixel difference matrix may be used as the calibration values.

The assessment tool 356 may be configured to test the calibration values determined for accuracy. In one example, the assessment tool 356 may apply the calibration values to the video frames 340a-340n of the replay record 302. The assessment tool 356 may determine whether or not the calibration values determined result in a desired image stabilize video frame output. For example, the assessment tool 356 may analyze the replay record 302 with the calibration values applied to determine an accuracy of the stabilized video frames when the total calibration is applied. In some embodiments, new video frames may be captured for use by the assessment tool 356. If the assessment tool 356 determines that the calibration values do not provide accurate calibration, the calibration process may be repeated. If the assessment tool 356 determines that the calibration values do provide accurate calibration, then the calibration operations 304 may present the signal CVAL to the memory 150 of the camera system 100 (e.g., the calibration for one particular zoom level may be complete and another one of the zoom levels may be calibration and/or another one of the camera systems 100a-100n may begin calibration).

The calibration values 306 may be stored in the memory 150. The calibration values 306 may be used to determine the total compensation for EIS at various different zoom levels. The calibration values 306 may comprise blocks 380a-380n. Each of the blocks 380a-380n may comprise a calibration value set for a particular zoom ratio. Each of the calibration value sets 380a-380n may comprise at least the scalar values k1, k2 and k3. For each of the zoom ratios implemented by the lens 160, there may be one group of fixed values stored in each one of the calibration value sets 380a-380n. The fixed calibration values in each of the calibration value sets 380a-380n may be unique for each particular zoom ratio (e.g., determined individually, but some values may be the same at different zoom levels). For example, the calibration operations 304 may be iterated once for each of the zoom levels (e.g., from 1× to n× zoom ratio levels) to determine the unique calibration value sets 380a-380n. In one example, the calibration value set 380a may correspond to the calibration values at 1× zoom ratio, the calibration value set 380b may correspond to the calibration values at 2× zoom ratio, the calibration value set 380c may correspond to the calibration values at 3× zoom level, etc., Each of the calibration value sets 380a-380n may comprise one (and only one) set of calibration values k1, k2, and k3 for a corresponding zoom level. The number of the calibration value sets 380a-380n may depend on the number of zoom levels implemented by the lens 160. The number of calibration value sets 380a-380n may be varied according to the design criteria of a particular implementation.

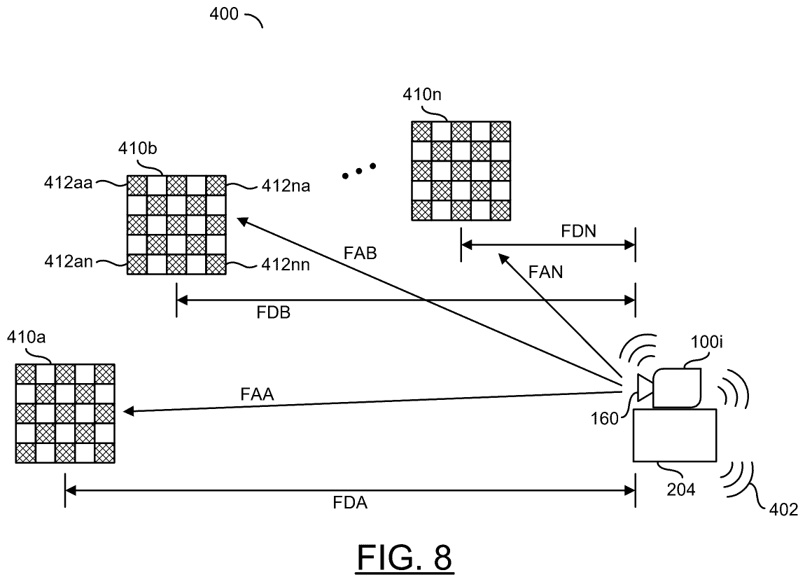

Referring to FIG. 8, a diagram illustrating a camera system capturing calibration targets is shown. A calibration environment 400 is shown. The calibration environment 400 may be used to calibrate the camera systems 100a-100n during mass production of the camera systems 100a-100n. The calibration environment 400 may enable a calibration technique that may be used to determine the calibration variables 306.

The calibration environment 400 may comprise the camera system 100i, the vibration device 204, vibration 402, and/or calibration targets 410a-410n. The calibration environment 400 may comprise one of the camera systems 100a-100n having the lens 160 supported by the vibration device 204. The vibration 402 may correspond to the vibration pattern VPTN generated by the vibration device 204. The camera system 100i may be a representative example of the camera systems 100a-100n. For example, each of the camera systems 100a-100n may be calibrated individually in the calibration environment 400 during mass production.

In the example shown, the camera system 100i is shown mounted on the vibration device 204 and aimed at the calibration targets 410a-410n. Generally, during the calibration technique each of the calibration targets 410a-410n may be arranged within a field of view of the lens 160. During mass production, the person (e.g., a technician/engineer) may move the camera systems 100a-100n to a particular distance from the calibration targets 410a-410n to enable the field of view to capture all of the calibration targets 410a-410n at a number of pre-determined zoom levels. The camera system 100i mounted on the vibration device 204 may represent one of the camera systems 100a-100n set up for the calibration technique.

The vibration device 204 is shown supporting the camera system 100i and applying the vibration 402 with the lens 160 at various distances (e.g., FDA-FDN) and angles (e.g., FAA-FAN) from the respective calibration targets 410a-410n. In an example, the distances FDA-FDN may be at least 1.5 meters away from the calibration targets 410a-410n. The vibration device 204 may be placed at the fixed distances FDA-FDN and at the fixed orientation (e.g., the fixed angles FAA-FAN) with respect to the calibration targets 410a-410n. For the calibration technique, the location of the camera system 100i may not be moved. Not moving the location of the camera system 100i may provide some of the time savings for the calibration technique. For example, the simulation framework 320 may enable the replay record 302 to contain the video sequence 330 comprising the video frames 340a-340n captured at various pre-defined zoom levels (e.g., iterate through each of the zoom levels 1× through n× without re-adjusting the location of the camera system 100i).

The calibration target 410b is shown comprising a calibration pattern 412aa-412nn. The calibration pattern 412aa-412nn shown on the calibration target 410b may be a representative example of the calibration pattern 412aa-412nn that may be used for each of the calibration targets 410a-410n (e.g., the calibration targets 410a-410n may each have the same pattern). In the example shown, the calibration pattern 412aa-412nn may comprise alternating light and dark (e.g., white and black) rectangles (e.g., a checkerboard/chessboard pattern). For example, the square 412aa may be a black square at a top left corner of the calibration target 410b, the square 412ba may be a white square on the top row and adjacent to the right of the 412aa, the square 412ab may be a white square on a second row from the top and directly below the square 412aa, etc. The number of squares in the calibration pattern 412aa-412nn may provide data points for the calibration result. The more rows and columns in the calibration pattern 412aa-412nn may provide more grids (e.g., data points). The greater the number of data points, the more accurate the result for the calibration values 306. The grid size for the calibration pattern 412aa-412nn may be no smaller than a pre-defined number in pixel units. In one example, regardless of the physical dimensions of the calibration targets 410a-410n, the grid size for the calibration pattern 412aa-412nn may be no smaller than 50×50 pixel units. For example, the 50×50 grid size limitation may be defined based on a standard of the minimum detectable bounding box in pixel units for CNN computer vision operations. Generally, the user may set up the calibration targets 410a-410n in the calibration environment 400 and adjust the distances FDA-FDN and the physical size accordingly.

The calibration pattern 412aa-412nn may implement various patterns. For example, some of the libraries (e.g., OpenCV) may enable using a dot pattern for the calibration targets 410a-410n instead of the chessboard pattern 412aa-412nn. The calibration pattern 412aa-412nn may be consistent for each of the calibration targets 410a-410n. Generally, the size, dimension and/or distances from the camera system 100i for the checkerboard image 412aa-412nn may be varied according to the design criteria of a particular implementation. Generally, the video frames 340a-340n for the full calibration technique may be YUV images and/or RGB images.

To perform the calibration technique during mass production, the person may mount the camera system 100i to the vibration device 204. Each customer (e.g., each camera provider) may demand and/or request that the zoom lens 160 be calibrated at different zoom levels (e.g., a number of pre-determined zoom levels). In some embodiments, the customer (e.g., the lens manufacturer) may provide a camera/lens projection type (e.g., the lens projection function). The calibration technique may comprise performing a calibration stage for EIS correction at each of the pre-determined zoom levels. In one example, a customer may provide one of the camera systems 100a-100n with pre-determined zoom levels ranging from 1× to 31×. In another example, a customer may provide one of the camera systems 100a-100n with pre-determined zoom levels ranging from 1× to 50×. Each calibration stage may provide the video frames 340a-340n that correspond to a different zoom levels. For each calibration stage, the optical zoom 202 of the lens 160 may be set to a different zoom level, and the video frames 340a-340n of the chessboard pattern 412aa-412nn of the calibration targets 410a-410 may be captured repeatedly in order to determine the calibration value sets 380a-380n for the particular zoom level. The captured video frames 340a-340n may be synchronized with the metadata 332 (e.g., comprising at least the movement information 342a) of the vibration pattern VPTN by the simulation framework 320.

The calibration technique may be a time consuming process. The simulation framework 320 may be implemented to save a significant amount of effort for the technician/engineer performing the calibration technique. For example, the users may arrange the calibration targets 410a-410n for the pre-determined zoom levels and then provide the initialization input signal INPUT (e.g., press the button 310) to enable the simulation framework 320 to start the calibration technique. During the calibration technique, the simulation framework 320 may record the data for the replay record 302 automatically for each zoom level (e.g., 1× to 30×) of the pre-determined zoom levels (e.g., the record stage).

During the calibration technique, after a set of the calibration values are determined (e.g., after the replay stage), the assessment tool 356 may analyze the EIS performed with the calibration values 306. If the calibration values 306 determine that the stabilized video frames are accurate, the calibration values 306 may be stored by the memory 150. After the calibration value sets 380a-380n have been determined for each of the zoom levels, then a next one of the camera systems 100a-100n may be mounted to the vibration device 204 for the calibration technique. If the evaluation result determined by the assessment tool 356 is determined to be not good enough (e.g., insufficient accuracy of the stabilization result), then the calibration images may have to be re-captured and updated calibration values 306 may be re-calculated. Multiple iterations of capturing calibration images of the calibration targets 410a-410n may be needed for the calibration operations 304 to generate calibration values that provide accurate compensation for the camera system 100i.

In some embodiments, for the calibration operations 304, the pre-defined known values for locations of the chessboard pattern 412aa-412nn may be stored in the memory 150. In an example, the total number of intersections of each of the squares of the calibration pattern 412aa-412nn (e.g., rows and columns) and the distances between the intersections of each of the squares in the calibration pattern 412aa-412nn for the calibration targets 410a-410n may be known (and stored) in advance. In some embodiments, the calibration operations 304 may perform computer vision operations based on the replay record 302 in order to detect the locations of the intersections of each of the squares in the calibration pattern 412aa-412nn for the calibration targets 410a-410. The pre-defined known values (or detected values may be the target values (e.g., gold standard or perfect values) for the calibration result.

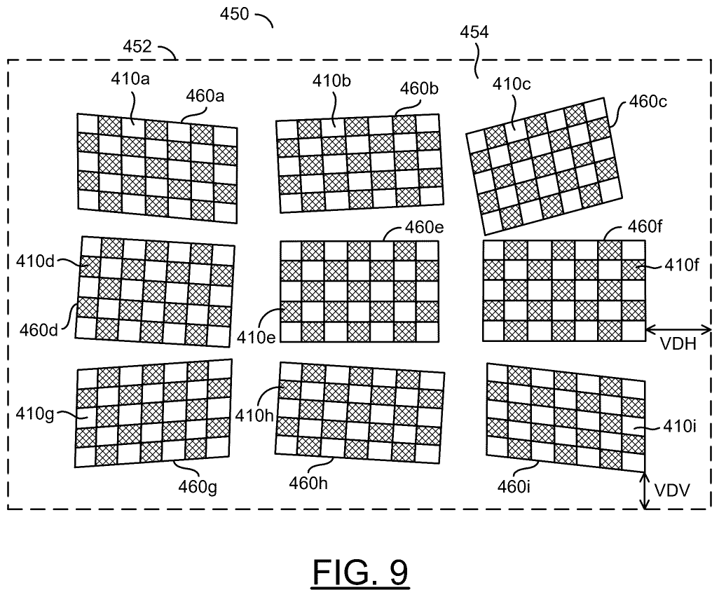

Referring to FIG. 9, a diagram illustrating a pre-defined arrangement of calibration targets is shown. An example pre-defined arrangement 450 is shown. The example pre-defined arrangement 450 may be shown as part of a video frame 452. The video frame 452 may be a representative example of one of the video frames 340a-340n in the replay record 302. The video frame 452 may represent a field of view captured by the lens 160.

The pre-defined arrangement 450 may comprise nine of the calibration targets 410a-410i. The calibration targets 410a-410i may be captured at different positions within the image view (e.g., the field of view) of the video frame 452. For example, each of the calibration targets 410a-410i may be at different distances FDA-FDN and different angles FAA-FAN from the lens 160 to enable the pre-defined arrangement 450.

Each of the calibration targets 310a-310i in the pre-defined arrangement 450 may comprise the calibration pattern 412aa-412nn. In the example shown, the calibration pattern 412aa-412nn may comprise a 7×5 grid of the alternating light/dark squares. While a 7×5 pattern is shown for illustrative purposes, the calibration pattern 412aa-412nn may comprise more than 5 rows and 7 columns. Generally, the more rows and columns for the calibration pattern 412aa-412nn, the more likely the calibration operations 304 may generate accurate results.

The pre-defined arrangement 450 may comprise the nine calibration targets 310a-310i. The nine calibration targets 310a-310i may be arranged as a 3×3 pattern in the video frame 452. In the example shown, the calibration target 410a may be a top left target, the calibration target 410b may be a top middle target, the calibration target 410c may be a top right target, the calibration target 410d may be a middle left target, the calibration target 410e may be a center target, the calibration target 410f may be a middle right target, the calibration target 410g may be a bottom left target, the calibration target 410h may be a bottom middle target and the calibration target 410i may be a bottom right target. The distance between each of the calibration targets 410a-410i may be more than 1.5 m. Larger distances may be used for the pre-defined arrangement 450. Generally, the larger the optical zoom 202, the larger the distance used for the pre-defined arrangement 450 in order to perform an accurate calibration. The calibration targets 310a-310i may be arranged at a distance that enables the calibration pattern 412aa-412nn to have at least the 50×50 pixel unit size.

White space 454 of the video frame 452 is shown. The white space 454 may not necessarily be white or empty. The white space 454 may represent a portion of the video frame 452 that may be outside of the space occupied by the calibration targets 410a-410i. For example, if the pre-defined arrangement 450 of the calibration targets 410a-410i is circumscribed within a rectangle, the white space 454 may be outside the circumscribed rectangle. The calibration targets 410a-410i are shown as a large proportion of the available space in the video frame 452 (e.g., the calibration targets 410a-410i occupy most of the field of view of the lens 160). The calibration targets 410a-410i may occupy more of the video frame 452 than the white space 454. In an example, the portion of the occupied space of the calibration targets 410a-410n of the video frame 452 (e.g., the field of view and/or the VIN domain) may be greater than 75% (e.g., the white space 454 outside the circumscribed rectangle of the calibration targets 410a-410i may be less than 25%).

Each of the calibration targets 410a-410i may have a respective orientation 460a-460i. The respective orientations 460a-460i may comprise an orientation of a plane of the calibration targets 410a-410i. The pre-defined arrangement 450 may comprise the calibration targets 410a-410i arranged such that the respective orientations 460a-460i may be different from each other. In one example, for accurate calibration during the calibration technique, the difference in the respective orientations 460a-460i may comprise a difference in angle between the planes of the calibration targets 410a-410i exceeding at least 10 degrees.

A double-ended arrow (e.g., VDH) and a double-ended arrow (e.g., VDV) is shown. The double-ended arrow VDH may represent a distance from an edge of one of the calibration targets 410f and the edge of the video frame 452 (e.g., edge of the horizontal field of view). The double-ended arrow VDV may represent a distance from an edge of one of the calibration targets 410i and the edge of the video frame 452 (e.g., edge of the vertical field of view). The distance VDH and the distance VDV may represent a size of the white space 454 around the calibration targets 410a-410i. While only two distances VDH and VDV are shown for illustrative purposes, there may be various distances from each of the calibration targets 410a-410i to the left edge, right edge, top edge and bottom edge of the video frame 452. In one example, the distance VDH and the distance VDV may represent a distance of the circumscribed rectangle containing the calibration targets 410a-410i to the edge of the video frame 452.

During the calibration technique, the vibration device 204 may apply the vibration pattern VPTN to the camera system 100i. The vibration pattern VPTN may cause the camera system 100i to shake. The shaking of the camera system 100i during the calibration technique may result in the pre-defined arrangement 450 of the calibration targets 410a-410i to move around in the video frame 452 (e.g., translational movement up and down and left and right and/or forward and backwards). The more vibration (e.g., the roll amplitude 234, the pitch amplitude 240 and/or the yaw amplitude 246), the more that the calibration targets 410a-410i may shift around in the field of view of the video frame 452. To ensure accurate calibration, the circumscribed rectangle of the calibration targets 410a-410i may need to be within the field of view at all times. For example, the pre-defined arrangement 450 may be implemented such that the distances VDH and VDV may be large enough to provide a sufficient amount of the white space 454 to ensure that none of the calibration targets 410a-410i (or portions of the calibration targets 410a-410i) move outside of the field of view of the video frame 452. Generally, the circumscribed rectangle of the pre-defined arrangement 450 of the calibration targets 410a-410i may need to always be within the VIN domain during the vibration pattern VPTN.

The distances FDA-FDN may be determined based on the optical zoom levels in the pre-defined zoom levels used for the calibration technique. The vibration device 204 and the camera system 100i may be located to ensure that the checkerboard pattern 412aa-412nn of each of the calibration targets 410a-410i occupies almost the full field of view of the lens 160 during the vibration pattern VPTN for each of the optical zoom levels, with the checkerboard pattern 412aa-412nn having at least the pixel unit size of 50×50. For the mass production using the calibration technique, the vibration device 204 and the camera system 100i may be adjusted once at the beginning of the calibration technique for each one of the camera systems 100a-100n by the person (e.g., an initial setup). Since the capture of the replay record 302 and the calibration operations 304 performed locally on the camera systems 100a-100n may be an automated process (e.g., initialized by pressing the button 310), no additional human interaction may be needed for the calibration operations 304 after the camera system 100i has been mounted and the calibration targets 410a-410i have been placed in the pre-defined arrangement 450. For example, when zoom ratio changes, the FOV of the lens 160 may change accordingly. As long as the pre-defined arrangement 450 of the calibration targets 410a-410i meet the criteria (e.g., distance, angles, FOV, white space, pixel unit size, etc.), the capture of the replay records 302 and/or the calibration operations 304 may be performed without the person changing the setup for the calibration targets 410a-410i. If the criteria cannot be met with a single arrangement of the calibration targets 410a-410i, then the person may change the setup after one or more of the zoom ratio changes in order to meet the calibration criteria.

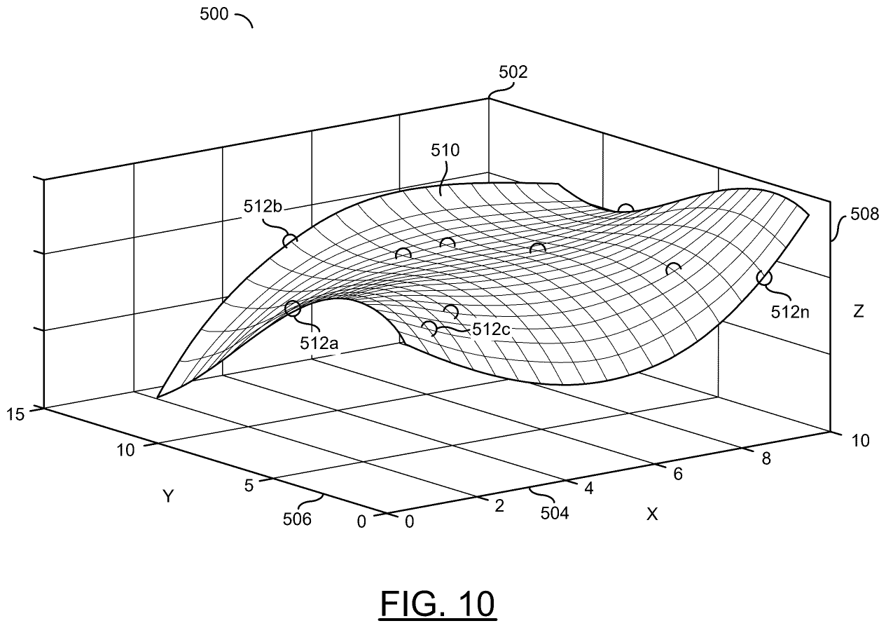

Referring to FIG. 10, a diagram illustrating a curve representing a total compensation implemented by a capture device is shown. An example total compensation curve 500 is shown. The example total compensation curve 500 may be represented as a three dimensional graph 502. The three dimensional graph 502 may comprise an axis 504, an axis 506 and/or an axis 506. The axis 504 may be an X-axis. The axis 506 may be a Y-axis. The axis 508 may be a Z-axis. The example total compensation curve 500 may be used to determine the calibration values 306 based on a desired total compensation.

The calibration technique may comprise applying the vibration pattern VPTN to one of the camera systems 100a-100n while the one of the camera systems 100a-100n captures video data of the pre-defined arrangement of the calibration targets 410a-410n for each of the pre-defined zoom levels. The particular pattern applied for the vibration pattern VPTN may not have a significant effect on the results of the calibration operations 304. The particular pattern applied for the vibration pattern VPTN may not need to be known in advance (e.g., the replay record 302 may capture the vibration pattern VPTN in real-time). Generally, if the vibration pattern VPTN is complex, more of the video frames 340a-3340n may be captured, which may be useful to calculate more accurate results for the calibration values 306. Generally, the technician performing the calibration during manufacturing may find a balance for accuracy and calibration time. The simulation framework 320 implemented by the SoC 312 may generate the replay record 302, and the replay record 302 may be used to perform the calibration operations 304.

In response to the replay record 302, the calibration operations 304 may be performed by the SoC 312. The video processing pipeline 350 may be configured to analyze and/or perform computer vision operations on each of the video frames 340a-340n in the video sequence 330. In an example, the video sequence 330 may comprise at least 600 of the video frames 340a-340n (e.g., YUV frames). More than 600 of the video frames 340a-340n may improve accuracy for determining the calibration values if the vibration pattern VPTN is complex. In another example, the video sequence 340a-340n may comprise compressed video frames (e.g., high quality HEVC I frames) save bandwidth of the DRAM of the memory 150 and/or to reduce I/O throughput writing into external storage.

To perform the calibration operations 304, the video processing module 350 may be configured to determine a location of the calibration pattern 412aa-412nn (e.g., the chessboard grid) for each of the calibration targets 410a-410n in each of the video frames 340a-340n. In an example, if the calibration pattern 412aa-412nn comprises a 7×5 grid (as shown in association with FIG. 9), then the video processing module 350 may generate one 7×5 matrix for each of the calibration targets 410a-410n in one of the video frames 340a-340n. For example, there may be one grid location matrix for each of the calibration targets 410a-410n for each of the video frames 340a-340n (e.g., n=1, 2, 3, . . . , frameID). In an example, one of the grid location matrices may be shown in a table (e.g., TABLE 1):

TABLE 1
FRAME J, TOP LEFT CALIBRATION TARGET

| | | | | | | |
|---|---|---|---|---|---|---|
| (x0, y0) | (x1, y0) | (x2, y0) | (x3, y0) | (x4, y0) | (x5, y0) | (x6, y0) |
| (x0, y1) | (x1, y1) | (x2, y1) | (x3, y1) | (x4, y1) | (x5, y1) | (x6, y1) |
| (x0, y2) | (x1, y2) | (x2, y2) | (x3, y2) | (x4, y2) | (x5, y2) | (x6, y2) |
| (x0, y3) | (x1, y3) | (x2, y3) | (x3, y3) | (x4, y3) | (x5, y3) | (x6, y3) |
| (x0, y4) | (x1, y4) | (x2, y4) | (x3, y4) | (x4, y4) | (x5, y4) | (x6, y4) |

The values in TABLE 1 may represent the locations of the squares of the calibration pattern 412aa-412nn of the calibration target 310a (e.g., the top left target in the pre-defined arrangement 450) for the video frame 340j in the video sequence 330 of the replay record 302. Generally, the calibration targets 410a-410n may comprise more than a 7×5 arrangement of the calibration pattern 412aa-412nn and TABLE 1 may comprise more location values than shown.

For each of the video frames 340a-340n in the replay record 302, there may be a larger, combined matrix representing all of the locations of the squares of the calibration pattern 412aa-412nn of all of the calibration targets 410a-410n. For an example of the 9×9 pre-defined arrangement 450 shown in association with FIG. 9, there may be three rows and three columns of 7×5 grid calibration targets 410a-410n, resulting in one larger matrix of (7*3)×(5*3)=21×15 (e.g., resulting in 315 chessboard grid locations for one YUV frame). Generally, there may be more than 315 chessboard grid locations (e.g., each of the calibration targets 410a-410n may comprise a larger grid than 7×5). The video processing module 350 may generate the grid locations for all of the calibration targets 410a-410n for all of the video frames 340a-340n in the replay record 302. The grid locations may be determined using the computer vision operations. The grid locations may be considered the estimated true values and/or the golden coordinate values.

The pixel difference module 352 may be configured to compare the grid locations generated by the video processing module 350 from the analysis of the video frames 340a-340n with data in the replay record 302. For example, the replay record 302 may comprise the movement information 342a generated by the IMU 106. Based on the replay record 302, the calibration operations 304 may be configured to determine grid locations for the calibration targets 410a-410n in response to EIS performed using the lens projection function and the motion information 342a (e.g., image stabilization performed using the contribution from the image stabilization compensation, but without the extra compensation). In response to the comparison of the EIS performed without extra compensation and the grid location coordinates determined by the video processing module 350 (e.g., partially shown in TABLE 1), the pixel difference module 352 may generate a pixel difference matrix. Generally, the lens manufacturer may provide information about the camera/lens projection type. After calibration, the lens distortion information can be calculated from the later curve fitting.

The pixel difference matrix may comprise a table of values. The values in the pixel difference matrix may comprise numerical values that indicate an amount that the result from image stabilization differs from the actual grid locations (e.g., the golden coordinate values) of the calibration pattern 412aa-412nn. In one example, the pixel difference matrix may comprise values in a number of pixels (e.g., a pixel unit value). In another example, the pixel difference matrix may comprise values in millimeters. In yet another example, the pixel difference matrix may comprise values in centimeters. The pixel difference matrix/table may be calculated by the pixel difference module 352 between golden coordinates determined from per-frame chessboard grid location and image stabilization operations performed without the extra compensation. An example pixel difference matrix is shown in a table (e.g., (TABLE 2):

TABLE 2
PIXEL DIFFERENCE MATRIX

| | | | | | | |
|---|---|---|---|---|---|---|
| 526 | 409 | 299 | 196 | 100 | . . . | −70 |
| 445 | 329 | 219 | 117 | 22 | . . . | −145 |
| 375 | 260 | 151 | 46 | −44 | . . . | −211 |
| 318 | 202 | 94 | −6 | −100 | . . . | −265 |
| . . . | . . . | . . . | . . . | . . . | . . . | . . . |
| 375 | 260 | 151 | 49 | −44 | . . . | −211 |

Example pixel difference values are shown in the pixel difference matrix of TABLE 2. Generally, there may be the same number of pixel difference values as in the large matrix of chessboard locations for each of the video frames 340a-340n. In the example pre-defined arrangement 450 (e.g., a 3×3 arrangement with calibration targets 410a-410n comprising a 7×5 chessboard pattern), there may be 315 pixel difference values (e.g., 21×15) in the pixel difference matrix. The number of pixel difference values and/or the size of the pixel difference matrix may be varied according to the design criteria of a particular implementation.

In some embodiments, for the chessboard calibration patterns 412aa-412nn in the images captured by the camera system 100i during the calibration technique, the calibration operations 304 may calculate a stabilization difference between the grid locations from the captured data and the reference (e.g., the pre-defined known values) for the real-world location of the calibration targets 410a-410n. The comparison provided in the pixel difference matrix used by the calibration operations 304 may be used to quantify the intrinsic characteristics of the lens 160. In response to the quantification of the intrinsic characteristics of the lens 160, the calibration operations 304 may generate the accurate calibration values.

The pixel difference matrix may be used by the curve fitting module 354 to determine the calibration values for the total compensation equation. The total compensation may be determined according to the equation EQ4. In the equation EQ4, the variables k1, k2 and k3 may be the calibration values 306 for one of the calibration value sets 380a-380n for a particular one of the zoom ratio levels. The parameter (k1*EFL*r), may be configured to fulfill a pitch/yaw/roll model. The parameter k2*h may be configured to provide an actual conversion from the raw data of the movement information 342a (e.g., raw data from the IMU 106) to angles. The parameter k3*r\hat{ }2 may be a distance from a point to the image center. For example, r\hat{ }2 may be equal to x\hat{ }2+y\hat{ }2, which may be simplified to k3*r\hat{ }2. The value r may be determined from the footage of the chessboard grid pattern 412aa-412nn recorded in the replay record 302.

A curve 510 is shown in the three dimensional graph 502. The curve 510 may plot of values in the pixel difference matrix. Plot points 512a-512n are shown on the curve 510. The plot points may represent the values of the pixel difference matrix. The curve fitting module 354 may be configured to evaluate the curve points 512a-512n of the curve 510 in order to determine the calibration variables 306 for a particular one of the calibration value sets 380a-380n (e.g., for one of the zoom ratio levels). For example, the calibration values 306 may be the values that enable the observed values from the pixel difference matrix to fit the equation EQ4. In an example, two values may be determined by fitting the curve 510. One variable may be a point (e.g., x,y) as r for the input values of the equation EQ4. Another variable may be a vibration frequency (e.g., h).

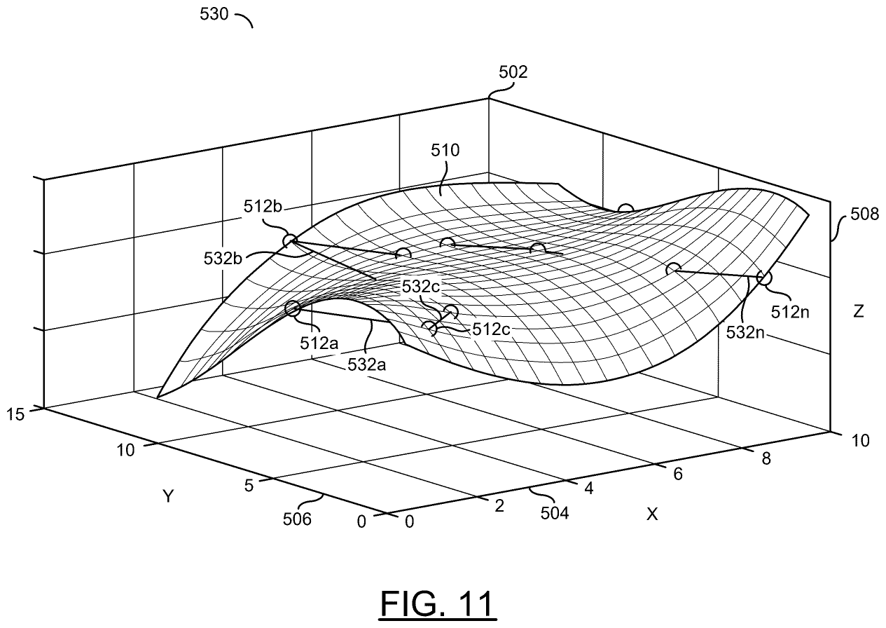

Referring to FIG. 11, a diagram illustrating curve-fitting to determine calibration values used for extra compensation is shown. An example total compensation curve fitting 530 is shown. The example total compensation curve fitting 530 may comprise the three dimensional graph 502. The three dimensional graph 502 may comprise the X-axis 504, the Y-axis 506 and the Z-axis 508 as shown in association with FIG. 10. The curve 510 is shown with the curve points 512a-512n.

The curve fitting module 354 may be configured to determine the calibration variables 306 (e.g., k1, k2, and k3 for each of the calibration value sets 380a-380n). The curve fitting calculation performed by the curve fitting module 354 may be a nonlinear fitting. In one example, the curve fitting implemented by the curve fitting module 354 may be a polynomial curve fitting with Taylor's Theorem.

The calibration values 306 may be determined at each zoom level of the pre-defined zoom levels. An example of the calibration values 306 determined for pre-defined zoom levels (e.g., the calibration value sets 380a-380n) may be shown in a table (e.g., TABLE 3):

TABLE 3
CALIBRATION VALUES FOR PRE-DEFINED ZOOM LEVELS

| ZOOM (EFL) | k1 | k2 | k3 |
|---|---|---|---|
| 1X | 0.01 | 0.01 | 0.016 |
| 2X | 0.06 | 0.05 | 0.128 |
| 3X | 0.17 | 0.13 | 0.16 |
| 4X | 0.2 | 0.19 | 0.25 |
| . . . | . . . | . . . | . . . |
| 31X | 0.41 | 0.38 | 0.39 |

Generally, for any given zoom ratio, there may be one group of fixed values (e.g., k1, k2, k3) that may be stored as one of the calibration value sets 380a-380n. The calibration values (e.g., k1, k2, k3) may have different values for each of the zoom ratios. The graph 530 may represent the curve fitting performed to determine one of the calibration value sets 380a-380n at one example specific zoom ratio level (e.g., the calibration values 306 for a zoom ratio value of 20×). With the compensation computed by the equation EQ4, the total compensation (e.g., the image stabilization with the extra compensation) may generate results very close to the golden location coordinates positions. For example, if the camera system 100i implements zoom ratio levels from 1× to 30×, the calibration operations 304 may iterate thirty times (e.g., perform thirty different pixel difference matrices and perform thirty different curve fittings) to generate the calibration value sets 380a-380n comprising thirty groups of values for k1, k2 and k3.

Lines 532a-532n are shown on the graph 502. The lines 532a-532n may represent curve fitting calculations. The curve fitting calculations 532a-532n may align results for the curve points 512a-512n to the curve 510 to determine the calibration values 306. The curve fitting calculations 532a-532n may determine the calibration values that enable the observed values from the pixel difference matrix to fit the equation EQ4.

The calibration operations 304 may be configured to evaluate the calibration values 306 determined by the curve fitting module 354. The assessment tool 356 may be configured to test the electronic image stabilization by performing the total compensation using the determined set of calibration values 380a-380n for a specific zoom ratio. For example, using the replay record 302, the assessment tool 356 may apply the image stabilization compensation and the extra compensation. The assessment tool 356 may test the electronic image stabilization for each of the zoom levels to ensure accuracy.

The assessment tool 356 may evaluate the result (e.g., the generated accurate calibration values 306). The assessment tool 356 may check whether the stabilized video frames provide accurate results for the lens 160. The assessment tool 356 may output a fitting error result. The fitting error result may be compared to a pre-determined threshold for accuracy. In an example, the pre-determined threshold may be a value within 1/16 of a pixel. The pre-determined threshold value may be determined based on an accuracy of a warping hardware block implemented by the processor 102. For example, 1/16 sub-pixel may be a limit of accuracy of the warp hardware block, which may set the minimum error for the calibration operations 304. After the curve fitting, the assessment tool 356 may ensure that a delta between the EIS compensated pixel position and the golden position calculated from chessboard grid locations is accurate within the minimum error.

The fitting error result may quantify an error level between the real distortion from the captured images and the calculated distortion from a fitting function. If the fitting error is close to zero pixels, then the calculated fitting function may exactly stabilize movement based on the intrinsic qualities of the lens 160 at the pre-defined zoom levels. If the error level is above the pre-determined threshold, then the calibration technique may be repeated. For example, the calibration technique may be repeated (e.g., using different vibration patterns and different replay records generated) until the fitting error determined by the assessment tool 356 is within the pre-determined threshold (e.g., 1/16 of a pixel).

In some embodiments, the assessment tool 356 may test the accuracy of the result of the calibration operations 304 without capturing new video frames. For example, the video sequence 330 of the replay record 302 may comprise sufficient data for the assessment tool 356. One portion (e.g., a majority) of the video frames 340a-340n may be used for to determine the calibration values 306 and another portion (e.g., a minority) of the video frames 340a-340n may be set aside for verification using the assessment tool 356. In one example, 80% of the video frames 340a-340n may be used to determine the calibration values 306 and 20% of the video frames 340a-340n may be used for verification using the assessment tool 356.

When the assessment tool 356 determines that the calibration values 306 are within the pre-determined threshold for accuracy, then the calibration operations 304 may be complete for one of the zoom ratio levels. The calibration values 306 generated may be stored by the SoC 312 of the camera system 100i (e.g., in the memory 150). For mass production, after the calibration values 306 are determined for the camera system 100i and stored (e.g., for all the zoom ratio levels), the technician/engineer may perform the calibration operations 304 for the next one of the camera systems 100a-100n. For example, the camera system 100i may be removed from the vibration device 204 and the next camera system 100j may be set up on the vibration device 204 and the calibration targets 410a-410n may be arranged in the pre-determined arrangement 450 with distances and/or angles suitable for each of the pre-determined zoom levels particular to the camera system 100j.

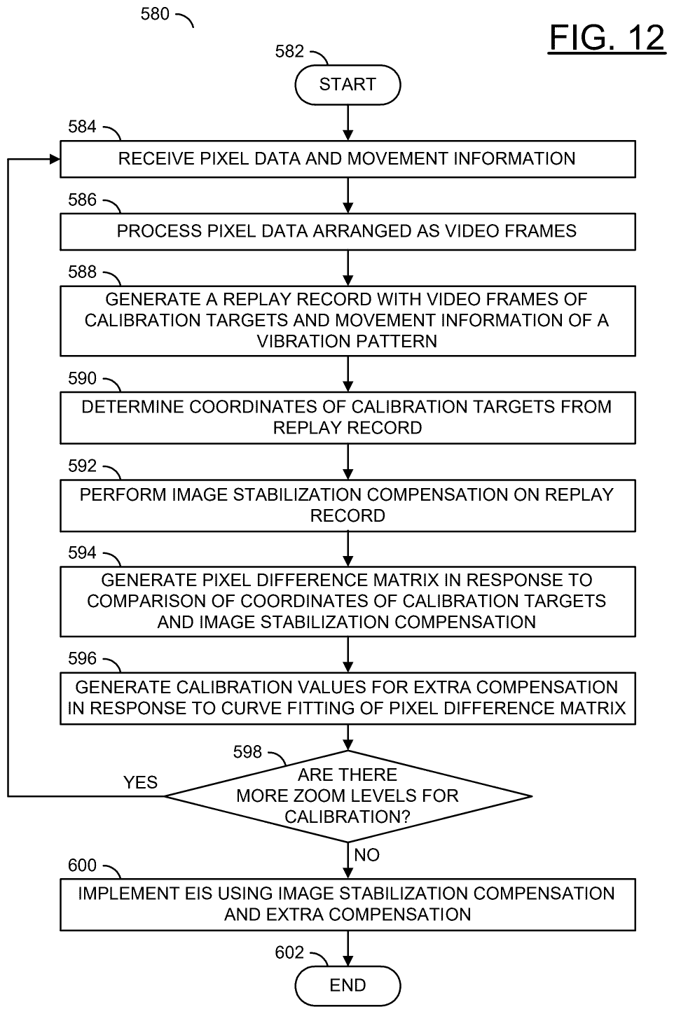

Referring to FIG. 12, a method (or process) 580 is shown. The method 580 may implement a large zoom ratio lens calibration for electronic image stabilization. The method 580 generally comprises a step (or state) 582, a step (or state) 584, a step (or state) 586, a step (or state) 588, a step (or state) 590, a step (or state) 592, a step (or state) 594, a step (or state) 596, a decision step (or state) 598, a step (or state) 600, and a step (or state) 602.

The step 582 may start the method 580. In the step 584, the capture device 104 may receive pixel data of the environment and the IMU 106 may receive movement information. For example, the lens 160 may receive the light input LIN, and the image sensor 180 may convert the light into raw pixel data (e.g., the signal VIDEO). In parallel, the gyroscope 186 may measure the movement MTN of the camera system 100 and the IMU 106 may convert the measurement to the movement information (e.g., the signal M_INFO). Next, in the step 586, the processor 102 may process the pixel data arranged as video frames. In some embodiments, the processor 102 may perform other operations on the pixel data arranged as video frames in addition to the EIS (e.g., perform computer vision operations, calculate depth data, determine white balance, etc.). In the step 588, the processor 102 and/or the memory 150 may generate the replay record 302 with the video sequence 330 (e.g., the video frames 340a-340n) capturing the calibration targets 410a-410n and the metadata 332 comprising at least the movement information 342a corresponding to the vibration pattern VPTN. For example, one of the camera systems 100a-100n may be connected to the vibration device 204, which may apply the vibration pattern VPTN while the SoC 312 implementing the simulation framework 320 generates the replay record 302. For example, capturing the video frames and metadata and generating the replay record 302 may be a recording portion of the calibration technique. Next, the method 580 may move to the step 590.

In the step 590, the processor 102 and/or the memory 150 may determine coordinates of the calibration targets 410a-410n from the video frames 340a-340n in the replay record 302. For example, the SoC 312 may perform the calibration operations 304. The calibration operations 304 may be a replay portion of the calibration technique. The SoC 312 may perform computer vision operations to determine the location of each grid of the calibration pattern 412aa-412nn. Next, in the step 592, the processor 102 may perform image stabilization compensation on the replay record 302. The image stabilization compensation may be the based on the lens optical projection functions and the motion information and without the extra compensation. In the step 594, the processor 102 may generate a pixel difference matrix (e.g., a pixel difference table) in response to a comparison of the coordinates of the calibration pattern 412aa-412nn of the calibration targets 410a-410n determined using computer vision (e.g., determined in the step 590) and the and the coordinates of the calibration pattern 412aa-412nn of the calibration targets 410a-410n determined based on the image stabilization compensation (e.g., determined in the step 592). Next, in the step 596, the processor 102 may generate the calibration values 306 for the extra compensation in response to performing a curve fitting for the pixel difference matrix. For example, the curve fitting may be configured to determine a solution to the equation EQ4 based on the pixel difference matrix. Next, the method 580 may move to the decision step 598.

In the decision step 598, the processor 102 may determine whether there are more zoom levels for the lens 160 for calibration. For example, the calibration operations 304 may be programmed with the number of zoom ratio levels for a particular lens 160 and/or camera model. The number of zoom ratio levels may be provided from a camera and/or lens manufacturer. If there are more zoom ratio levels for calibration, then the method 580 may return to the step 584. For example, calibration operations 304 may be performed to determine a set of calibration values for each of the calibration value sets 380a-380n. If there are no more zoom ratio levels for calibration, then the method 580 may move to the step 600. In the step 600, the processor 102 may implement the EIS using the total compensation (e.g., a combination of the image stabilization compensation and the extra compensation using one of the calibration value sets 380a-380n that corresponds to the zoom ratio level that captured the video frames). Next, the method 580 may move to the step 602. The step 602 may end the method 580.

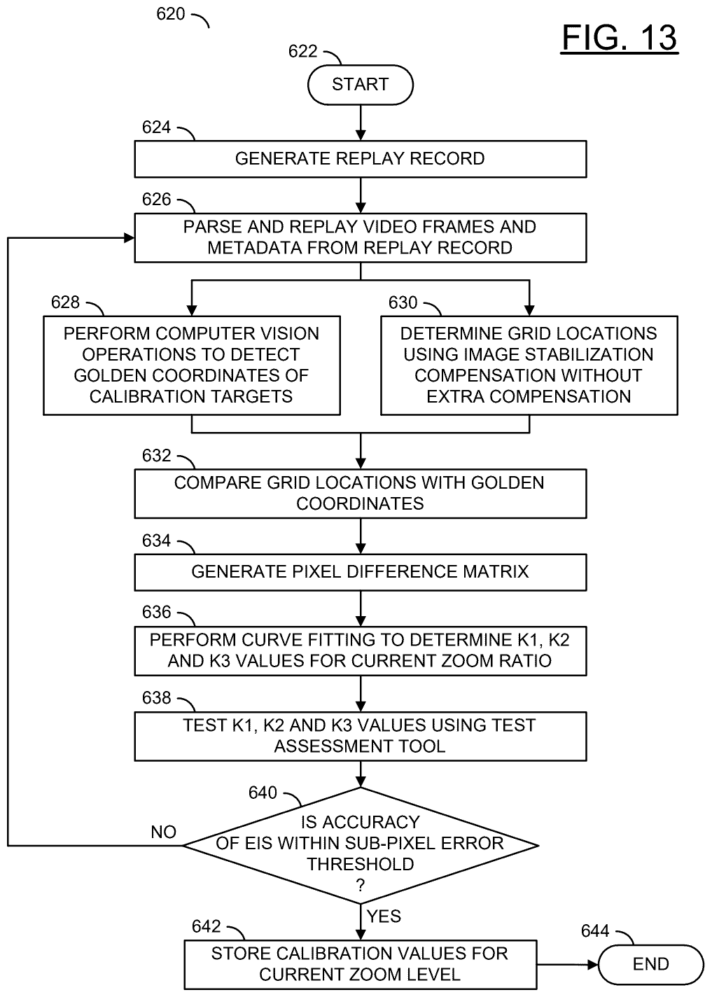

Referring to FIG. 13, a method (or process) 620 is shown. The method 620 may perform calibration operations in response to a replay recording. The method 620 generally comprises a step (or state) 622, a step (or state) 624, a step (or state) 626, a step (or state) 628, a step (or state) 630, a step (or state) 632, a step (or state) 634, a step (or state) 636, a step (or state) 638, a decision step (or state) 640, a step (or state) 642, and a step (or state) 644.

The step 622 may start the method 620. In the step 622, the simulation framework 320 may generate the replay record 302. Next, in the step 626, the video processing pipeline 350 (e.g., the iDSP) may parse and replay the video frames 340a-340n and the metadata 332 from the replay record 302. Next, the method 620 may move to the step 628 and the step 630. In one example, the steps 628-630 may be performed in parallel and/or substantially in parallel. In another example, the steps 628-630 may be performed sequentially. If performed sequentially, which of the steps 628-630 is performed first may be varied according to the design criteria of a particular implementation.

In the step 628, the video processing pipeline 350 may perform computer vision operations to detect golden coordinates of the calibration targets 410a-410n. For example, the golden coordinates may be an estimated true real-world location of each grid 412aa-412nn of each of the calibration targets 410a-410n in one of the video frames 340a-340n. Generally, the calibration values 306 may be calculated to enable the results of the EIS to achieve the golden coordinates if applied to the video frames 340a-340n. Next, the method 620 may move to the step 632. In the step 630, the video processing pipeline 350 may determine the grid locations using image stabilization without the extra compensation. For example, the video processing pipeline 350 may apply the image stabilization operations on the video frames 340a-340n and then perform computer vision operations to determine the locations of each of the grids 412aa-412nn. Next, the method 620 may move to the step 632.

In the step 632, the pixel difference module 532 may compare the grid locations determined using the image stabilization compensation with the golden coordinates. Next, in the step 634, the pixel difference module 532 may generate the pixel difference matrix (e.g., TABLE 2). The pixel difference matrix may be determined based on the comparison of the grid locations determined using the image stabilization compensation and the golden coordinates. In the step 636, the curve fitting module 354 may perform curve fitting based on the equation EQ4 to determine the particular one of the calibration value sets 380a-380n that corresponds to the current zoom ratio. For example, the calibration value set may comprise the calibration values k1, k2, and k3 that enable the equation EQ4 to provide a solution for the values in the pixel difference matrix. Next, in the step 638, the assessment tool 356 may test the k1, k2 and k3 values. For example, the assessment tool 356 may apply the electric image stabilization using the total compensation based on the particular one of the calibration value sets 380a-380n for the current zoom level on a subset of the video frames 340a-340n in the replay record 302. Next, the method 620 may move to the decision step 640.

In the decision step 640, the assessment tool 356 may determine whether the accuracy of the EIS when using the determined calibration values k1, k2 and k3 provides results within the sub-pixel error threshold. For example, the sub-pixel error threshold may be 1/16 of a pixel. If the accuracy of the EIS is not within the sub-pixel error threshold, then the method 620 may return to the step 626 to repeat the calibration operations 304 and re-calculate the calibration values. If the accuracy of the EIS is within the sub-pixel error threshold, then the method 620 may move to the step 642. In the step 642, the processor 102 may store the calibration values determined for the current zoom level as one of the calibration value sets 380a-380n of the calibration values 306. For example, the calibration values 306 may be stored in the memory 150. Next, the method 620 may move to the step 644. The step 644 may end the method 620.

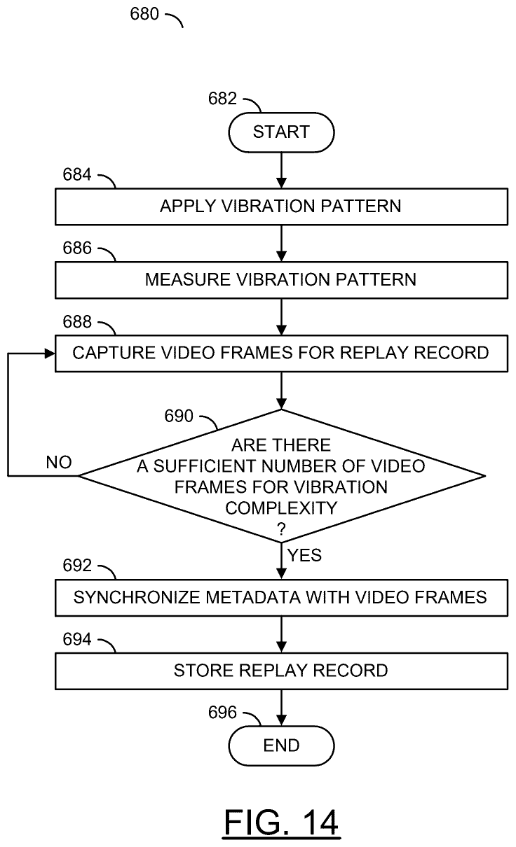

Referring to FIG. 14, a method (or process) 680 is shown. The method 680 may capture a recording of calibration targets for a replay record during a vibration pattern. The method 680 generally comprises a step (or state) 682, a step (or state) 684, a step (or state) 686, a step (or state) 688, a decision step (or state) 690, a step (or state) 692, a step (or state) 694, and a step (or state) 696.

The step 682 may start the method 680. In the step 684, the vibration device 204 may apply the vibration pattern VPTN to one of the camera systems 100a-100n. Next, in the step 686, the IMU 106 may measure the vibration pattern VPTN as the motion input MTN. In the step 688, the capture device 104 may capture the video frames for the replay record 302. Generally, the step 686 and the step 688 may be captured in parallel (e.g., the motion input MTN and the pixel data may be captured simultaneously). Next, the method 680 may move to the decision step 690.

In the decision step 690, the simulation framework 320 may determine whether there are a sufficient number of video frames for the complexity of the vibration pattern VPTN. Generally, at least 600 of the video frames 340a-340n may be captured for the replay record 302. However, additional video frames may be captured depending on the complexity of the vibration pattern VPTN. If there is an insufficient amount of video frames captured, then the method 680 may return to the step 688. If there is a sufficient amount of video frames captured, then the method 680 may move to the step 692. In the step 692, the simulation framework 320 may synchronize the metadata 332 with the video sequence 330. For example, the motion information, image sensor exposure shutter timing, exposure start timing, resolution information, etc. may be synchronized with the captured video frames 340a-340n. Next, in the step 694, the replay record 302 may be stored in the memory 150. Next, the method 680 may move to the step 696. The step 696 may end the method 680.

In some embodiments, the calibration operations 304 may be performed after the replay record 302 is generated for one of the zoom levels of the lens 160. For example, the lens 160 may be set to a zoom level of 1×, the replay record 302 may be generated for the 1× zoom level, and then the calibration operations 304 may determine the calibration value set 380a corresponding to the 1× zoom level, before the zoom level of the lens 160 is changed to the 2× zoom level, etc., In some embodiments, the calibration technique may capture one of the replay records 302 for all of the zoom levels first before performing any of the calibration operations 304. For example, the replay record 302 may be generated for the 1× zoom level, then the 2× zoom level, then the 3× zoom level, etc. until the replay record 302 has been generated for each of the zoom levels. Then the calibration operations 304 may later use the replay records 302 generated for each zoom level to determine all of the calibration value sets 380a-380n. Whether the replay records 302 are generated one at a time or in sequence one after another may be varied according to the design criteria of a particular implementation.

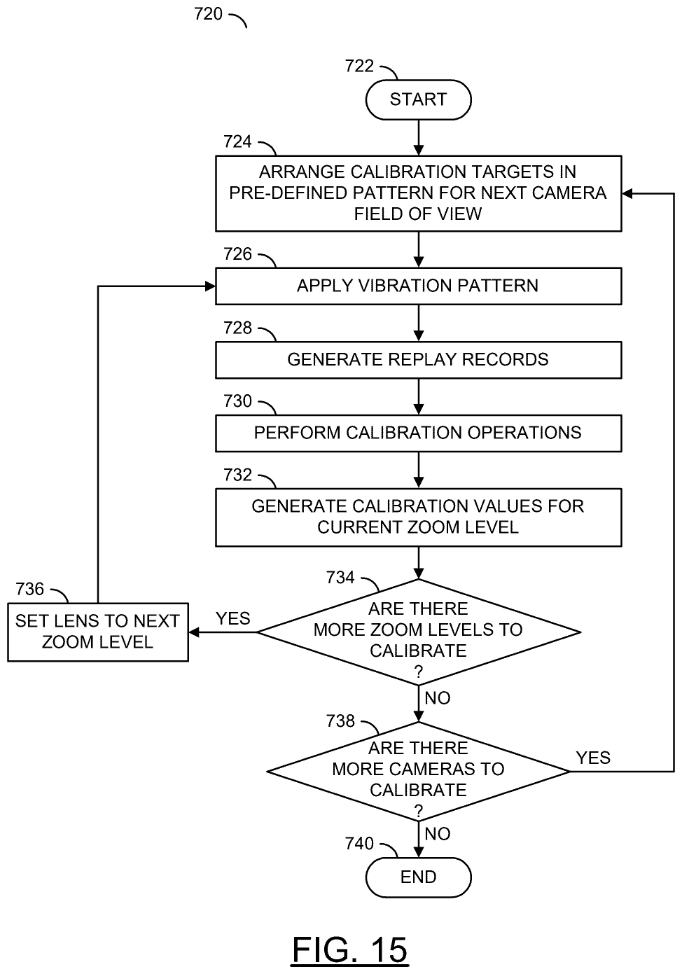

Referring to FIG. 15, a method (or process) 720 is shown. The method 720 may generate calibration values for cameras during camera manufacturing. The method 720 generally comprises a step (or state) 722, a step (or state) 724, a step (or state) 726, a step (or state) 728, a step (or state) 730, a step (or state) 732, a decision step (or state) 734, a step (or state) 736, a decision step (or state) 738, and a step (or state) 740.

The step 722 may start the method 720. In the step 724, a user (e.g., a technician/engineer/calibration personnel) may arrange the calibration targets 410a-410n in the pre-defined pattern 450 for the field of view of a next one of the camera systems 100a-100n. Ideally, for a camera that implements auto-focus, the calibration targets 410a-410n may be arranged such that the criteria for the calibration operations 304 (e.g., the distances, the respective angles, the calibration targets 410a-410n remaining within the field of view, the grid size for the calibration pattern 412aa-412nn being no smaller than the pixel units minimum threshold, etc.) may be met for all of the zoom levels of the lens 160. Next, in the step 726, the vibration device 204 may apply the vibration pattern VPTN to the one of the camera systems 100a-100n. In the step 728, the simulation framework 320 may generate the replay record 302. For example, the user may apply the signal INPUT (e.g., press the button 310) to initiate the calibration technique. In some embodiments, the entire calibration process may be performed automatically with the press of the button 310 (e.g., if no change to the arrangement of the calibration targets 410a-410n provides a benefit). Next, in the step 730, the SoC 312 may perform the calibration operations 304. In the step 732, the calibration operations 304 may generate one of the calibration value sets 380a-380n for the current zoom level. Next, the method 720 may move to the decision step 734.

In the decision step 734, the calibration operations 304 may determine whether there are more zoom levels for the lens 160 to calibrate. For example, if there are zoom levels from 1× to 30× then there may be thirty iterations of the steps 726-732 to generate each of the calibration value sets 380a-380n. If there are more zoom levels to calibrate, then the method 720 may move to the step 736. In the step 736, the lens 160 may be set to the next optical zoom level. For example, the zoom lens motor may adjust the zoom level. If the arrangement of the calibration targets 410a-410n does not meet the criteria for the calibration technique, then the method 720 may move to the step 724 and the calibration targets 410a-410n may be adjusted. If no adjustment to the calibration targets 410a-410n is needed, then the method 720 may return to the step 726 (e.g., to begin the next zoom level iteration for determining the calibration values for the particular one of the camera systems 100a-100n). In the decision step 734, if there are no more zoom levels to calibrate for the one of the camera systems 100a-100n, then the method 720 may move to the decision step 738. For example, once all the calibration value sets 380a-380n have been determined for one of the camera systems 100a-100n, the calibration may be completed for one camera.

In the decision step 738, the user may determine whether there are more of the camera systems 100a-100n to calibrate. The number of camera systems 100a-100n to calibrate may depend on the number of cameras being manufactured. If there are more of the camera systems 100a-100n to calibrate, then the method 720 may return to the step 724. For example, the calibration targets 410a-410n may be re-adjusted for the next one of the camera systems 100a-100n to begin calibration of the next camera. If there are no more of the cameras 100a-100n to calibrate, then the method 720 may move to the step 740. The step 740 may end the method 720.

The functions performed by the diagrams of FIGS. 1-15 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU), video digital signal processor (VDSP) and/or similar computational machines, programmed according to the teachings of the specification, as will be apparent to those skilled in the relevant art(s). Appropriate software, firmware, coding, routines, instructions, opcodes, microcode, and/or program modules may readily be prepared by skilled programmers based on the teachings of the disclosure, as will also be apparent to those skilled in the relevant art(s). The software is generally executed from a medium or several media by one or more of the processors of the machine implementation.

The invention may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips or die arranged as flip-chip modules and/or multi-chip modules or by interconnecting an appropriate network of conventional component circuits, as is described herein, modifications of which will be readily apparent to those skilled in the art(s).

The invention thus may also include a computer product which may be a storage medium or media and/or a transmission medium or media including instructions which may be used to program a machine to perform one or more processes or methods in accordance with the invention. Execution of instructions contained in the computer product by the machine, along with operations of surrounding circuitry, may transform input data into one or more files on the storage medium and/or one or more output signals representative of a physical object or substance, such as an audio and/or visual depiction. Execution of instructions contained in the computer product by the machine, may be executed on data stored on a storage medium and/or user input and/or in combination with a value generated using a random number generator implemented by the computer product. The storage medium may include, but is not limited to, any type of disk including floppy disk, hard drive, magnetic disk, optical disk, CD-ROM, DVD and magneto-optical disks and circuits such as ROMs (read-only memories), RAMs (random access memories), EPROMs (erasable programmable ROMs), EEPROMs (electrically erasable programmable ROMs), UVPROMs (ultra-violet erasable programmable ROMs), Flash memory, magnetic cards, optical cards, and/or any type of media suitable for storing electronic instructions.

The elements of the invention may form part or all of one or more devices, units, components, systems, machines and/or apparatuses. The devices may include, but are not limited to, servers, workstations, storage array controllers, storage systems, personal computers, laptop computers, notebook computers, palm computers, cloud servers, personal digital assistants, portable electronic devices, battery powered devices, set-top boxes, encoders, decoders, transcoders, compressors, decompressors, pre-processors, post-processors, transmitters, receivers, transceivers, cipher circuits, cellular telephones, digital cameras, positioning and/or navigation systems, medical equipment, heads-up displays, wireless devices, audio recording, audio storage and/or audio playback devices, video recording, video storage and/or video playback devices, game platforms, peripherals and/or multi-chip modules. Those skilled in the relevant art(s) would understand that the elements of the invention may be implemented in other types of devices to meet the criteria of a particular application.

The terms “may” and “generally” when used herein in conjunction with “is (are)” and verbs are meant to communicate the intention that the description is exemplary and believed to be broad enough to encompass both the specific examples presented in the disclosure as well as alternative examples that could be derived based on the disclosure. The terms “may” and “generally” as used herein should not be construed to necessarily imply the desirability or possibility of omitting a corresponding element.

The designations of various components, modules and/or circuits as “a”-“n”, when used herein, disclose either a singular component, module and/or circuit or a plurality of such components, modules and/or circuits, with the “n” designation applied to mean any particular integer number. Different components, modules and/or circuits that each have instances (or occurrences) with designations of “a”-“n” may indicate that the different components, modules and/or circuits may have a matching number of instances or a different number of instances. The instance designated “a” may represent a first of a plurality of instances and the instance “n” may refer to a last of a plurality of instances, while not implying a particular number of instances.

While the invention has been particularly shown and described with reference to embodiments thereof, it will be understood by those skilled in the art that various changes in form and details may be made without departing from the scope of the invention.

1. An apparatus comprising:
an interface configured to receive (i) pixel data of an environment and (ii) movement information about said apparatus; and
a processor configured to (i) process pixel data arranged as video frames, (ii) measure movement information, (iii) generate a replay record in response to (a) said video frames of calibration targets captured during a vibration pattern applied to said apparatus and (b) said movement information of said vibration pattern, (iv) implement an image stabilization compensation in response to (a) a lens projection function and (b) said movement information, (v) perform an extra compensation in response to calibration values and (vi) perform calibration operations to determine said calibration values, wherein (i) said replay record comprises said video frames generated at a plurality of pre-defined zoom levels of a lens and (ii) said calibration operations comprise
(I) determining coordinates of said calibration targets for each of said video frames in said replay record,
(II) determining a pixel difference matrix in response to a comparison of said video frames determined with said image stabilization compensation and said coordinates of said calibration targets, and
(III) generating said calibration values in response to a curve fitting performed on said pixel difference matrix.

2. The apparatus according to claim 1, wherein (i) said calibration operations are further configured to implement an assessment tool and (ii) said assessment tool is configured to test stabilized video frames generated by said processor in response to applying said image stabilization compensation and said extra compensation using said calibration values.

3. The apparatus according to claim 2, wherein said assessment tool is configured to ensure an accuracy of said stabilized video frames is within 1/16 of a pixel.

4. The apparatus according to claim 1, wherein said calibration targets comprise a set of nine chessboard patterns arranged in a pre-defined pattern.

5. The apparatus according to claim 4, wherein said pre-defined pattern is (i) a distance of at least 1.5 m from said lens and (ii) within a field of view of said lens during said vibration pattern.

6. The apparatus according to claim 4, wherein (i) said pre-defined pattern comprises each of said nine chessboard patterns having planes arranged at different angles and (ii) said different angles are at least 10 degrees difference between each of said planes.

7. The apparatus according to claim 4, wherein (i) said pixel difference matrix comprises data points corresponding to each grid coordinate for each of said calibration targets and (ii) each grid coordinate is no smaller than 50×50 pixel units.

8. The apparatus according to claim 1, wherein (i) said vibration pattern is applied to said apparatus while said video frames of said calibration targets are generated and (ii) an inertial measurement unit of said apparatus measures said movement information of said vibration pattern.

9. The apparatus according to claim 8, wherein said vibration pattern is generated by a shaker device used on said apparatus.

10. The apparatus according to claim 1, wherein (i) said processor is configured to implement a simulation framework and (ii) said simulation framework is configured to synchronize said video frames with said movement information for said replay record.

11. The apparatus according to claim 10, wherein (i) said replay record comprises metadata and (ii) said metadata comprises said movement information, image sensor exposure shutter timing and exposure start timing.

12. The apparatus according to claim 10, wherein said video frames of said replay record comprise at least 600 YUV sequences of said pixel data.

13. The apparatus according to claim 10, wherein said video frames of said replay record comprise high quality compressed frames of said pixel data.

14. The apparatus according to claim 10, wherein said simulation framework is configured to automatically generate said replay record for each of said plurality of pre-defined zoom levels in response to a trigger input.

15. The apparatus according to claim 1, wherein (i) said processor is configured to implement a calibration stage for each of said plurality of pre-defined zoom levels and (ii) said calibration stage comprises (a) determining said coordinates of said calibration targets for each of said video frames in said replay record that correspond to one of said plurality of pre-defined zoom levels, (b) determining said pixel difference matrix for each of said pre-defined zoom levels and (c) generating a set of said calibration values for each of said pre-defined zoom levels.

16. The apparatus according to claim 1, wherein (i) said vibration pattern comprises a combination of a vibration in a pitch direction, a vibration in a roll direction, and a vibration in a yaw direction and (ii) each of said vibration in said pitch direction, said vibration in said roll direction, and said vibration in a yaw direction comprises a respective vibration frequency and a vibration amplitude.

17. The apparatus according to claim 1, wherein said movement information comprises one or more of a maximum amplitude, an actual amplitude, an actual angle value, a vibration frequency and a vibration duration.

18. The apparatus according to claim 1, wherein a total amount of compensation for stabilized video frames generated by said processor is a combination of said image stabilization compensation and said extra compensation.

19. The apparatus according to claim 18, wherein (i) said total amount of compensation is determined according to an equation: Final_comp=R [k1*EFL*r,k2*h,k3*r\hat{ }2] and (ii) said calibration values comprise k1, k2 and k3.

20. The apparatus according to claim 1, wherein said curve fitting performed on said pixel difference matrix comprises polynomial curve fitting with Taylor's theorem.
